(19) United States
(12) Patent Application Publication
(10) Pub. No.: US 2024/0426980 A1
(43) Pub. Date: Dec. 26, 2024

(54) LIGHTING MODULE AND OPTICAL APPARATUS THEREOF

(71) Applicants: Sintai Optical (Shenzhen) Co., Ltd., ShenZhen City (CN); Asia Optical Co., Inc., Taichung (TW)

(72) Inventors: Ling-Wei Zhao, ShenZhen City (CN); Xiao-Yao Zhang, ShenZhen City (CN); Yue-Ye Chen, ShenZhen City (CN); Hua-Tang Liu, Taichung (TW); Guo-Shun Huang, Taichung (TW); Yung-Hsiao Huang, Taichung (TW); Hsien-Chi Lin, Taichung (TW); Yao Pei, ShenZhen City (CN)

(21) Appl. No.: 18/743,340

(22) Filed: Jun. 14, 2024

(30) Foreign Application Priority Data
Jun. 26, 2023 (CN) 202310766687.9

(51) Int. Cl. G01S 7/481; G02B 9/64; G02B 26/12

(52) U.S. Cl. CPC G01S 7/4817; G01S 7/4815; G01S 7/4816; G02B 9/64; G02B 26/123

(57) ABSTRACT

A lighting module includes a lighting unit, a cylindrical optical element, a supporting unit, and a base. The supporting unit connects the base and a part of the supporting unit is higher than a junction of the base and the supporting unit. The lighting unit is disposed on the base and includes a lighting surface emitting a light beam. The cylindrical optical element includes an incident surface and both ends of the cylindrical optical element are respectively connected to the supporting unit making the incident surface facing the lighting surface and having an interval from the lighting unit to the incident surface, and the light beam enters the cylindrical optical element from the incident surface. The lighting module satisfies the following condition: 2≤D/E≤6; wherein D is a diameter of the cylindrical optical element and E is the interval from the lighting unit to the incident surface.

### BACKGROUND OF THE INVENTION

### Field of the Invention

The present invention relates to a lighting module and optical apparatus thereof.

### Description of the Related Art

The divergence angle of a light beam in the fast-axis direction is greater than that of in the slow-axis direction for the light beam emitted by a traditional laser diode, so that the spot of the traditional laser beam is elliptical. The divergence angle of the light beam in the fast-axis direction is large, resulting in poor collimation for the light beam and the beam energy in the fast-axis direction is easily lost, which is not conducive to laser diode application. Therefore, when using optical apparatus having transmitting and receiving functions developed from traditional laser diode making the scanning precision is poor and the scanning range is small and cannot meet today's requirement.

### BRIEF SUMMARY OF THE INVENTION

The main purpose of the present invention is to provide a lighting module, wherein the light beam divergence angle in the fast-axis direction of the lighting module has been compressed, so that the spot for the light beam no longer deviates far from circle and the collimation of the light beam has been improved. When the lighting module of the present invention is applied to an optical apparatus having transmitting and receiving functions, the scanning precision and scanning range of the optical apparatus can be effectively improved.

The lighting module in accordance with an exemplary embodiment of the invention includes a lighting unit, a cylindrical optical element, a supporting unit, and a base. The supporting unit connects the base and a part of the supporting unit is higher than a junction of the base and the supporting unit. The lighting unit is disposed on the base and includes a lighting surface emitting a light beam. The cylindrical optical element includes an incident surface and both ends of the cylindrical optical element are respectively connected to the supporting unit making the incident surface facing the lighting surface and having an interval from the lighting unit to the incident surface, and the light beam enters the cylindrical optical element from the incident surface. The lighting module satisfies the following condition: 2≤D/E≤6; wherein D is a diameter of the cylindrical optical element and E is the interval from the lighting unit to the incident surface.

In another exemplary embodiment, the lighting unit is a laser diode; the cylindrical optical element is a rod lens, a cylindrical lens, an optical fiber, or a fast-axis collimating lens; and one of the cylindrical optical elements can correspond to one or more of the lighting units.

The optical apparatus in accordance with another exemplary embodiment of the invention includes a transmitting module and a receiving module. The transmitting module includes a lighting module and a collimator. The receiving module includes a receiving lens and an optical receiver. The light beam emitted by the lighting module first enters and penetrates the collimator, then enters an object and is reflected by the object, then enters and penetrates the receiving lens, and finally enters the optical receiver.

The optical apparatus in accordance with yet another exemplary embodiment of the invention includes a transmitting module and a receiving module. The transmitting module includes a first lighting module array and a collimator, the first lighting module array includes a plurality of lighting modules and the lighting modules are arranged along a slow-axis direction of the lighting module. The lighting surfaces include respectively a center point. The receiving module includes a receiving lens and a first optical receiver array and the first optical receiver array includes a plurality of optical receivers. The light beams emitted by the first lighting module array first enters and penetrates the collimator respectively, then enters an object and is reflected by the object, then enters and penetrates the receiving lens, and finally enters the optical receivers of the first optical receiver array, respectively. The optical apparatus satisfies at least one of the following conditions: Y≤31 mm; 0.90≤Y/(2×fts×tan(ω))≤1.10; 0.90≤Y/((n−1)×L+d)≤1.10; 0.90≤H/(2×fr×tan(ω))≤1.10; wherein Y is an interval from the first lighting surface to the last lighting surface along the slow-axis direction for the first lighting module array; n is a total number of the lighting modules; L is an interval between two center points of the two lighting surfaces of the two adjacent lighting modules for the first lighting module array; d is a slow-axis length of the lighting surface; fts is an effective focal length of the lighting module in the slow-axis direction for the transmitting module; ω is a half field of view angle of the transmitting module; H is an interval from a center point of the first optical receiver to a center point of the last optical receiver for the first optical receiver array; and fr is an effective focal length of the receiving module.

In another exemplary embodiment, the optical apparatus satisfies at least one of the following conditions: 0.90≤L/(2×fts×tan(β))≤1.10; 0.90≤β/(n×β)≤1.10; 0.90≤I/(2×fr×tan(β))≤1.10; wherein L is the interval between the two center points of the two lighting surfaces of the two adjacent lighting modules for the first lighting module array; fts is the effective focal length of the lighting module in the slow-axis direction for the transmitting module; β is a half of an angle between the two slow-axis direction beams of the two adjacent lighting modules after passing through the collimator for the first lighting module array; ω is the half field of view angle of the transmitting module; n is the total number of the lighting modules; I is an interval between two center points of the two adjacent optical receivers for the first optical receiver array; and fr is the effective focal length of the receiving module.

In yet another exemplary embodiment, a first virtual line is perpendicular to the lighting surface, passes through its center point, and connects the incident surface to a virtual point; a second virtual line connects the center point of any adjacent lighting surfaces and the virtual point; Ang is an angle between the first virtual line and the second virtual line; and the optical apparatus satisfies the following condition: 45 degrees≤Ang≤89 degrees.

In another exemplary embodiment, the optical apparatus further includes a second lighting module array and a second optical receiver array, the second lighting module array includes another plurality of lighting modules and the another plurality of lighting modules are arranged along another slow-axis direction of the another lighting module; the first lighting module array and the second lighting module array are respectively disposed on both sides of an optical axis of the collimator; the second optical receiver array includes another plurality of optical receivers; the first optical receiver array and the second optical receiver array are respectively disposed on both sides of an optical axis of the receiving lens; and the light beams emitted by the second lighting module array first enters and penetrates the collimator respectively, then enters the object and is reflected by the object, then enters and penetrates the receiving lens, and finally enters the another plurality of optical receivers of the second optical receiver array respectively.

In yet another exemplary embodiment, the optical apparatus satisfies at least one of the following conditions: 0.90≤y/(2×fts×tan(α))≤1.10; 0.90≤h/(2×fr×tan(α))≤1.10; 1.71≤α/β≤1.89; wherein y is a center interval from the first lighting module array to the second lighting module array; fts is the effective focal length of the lighting module in the slow-axis direction for the transmitting module; α is a half of an angle between the two fast-axis direction beams of the two closest lighting modules respectively in the first lighting module array and the second lighting module array after passing through the collimator; h is a center interval from the first optical receiver array to the second optical receiver array; fr is the effective focal length of the receiving module; and β is the half of the angle between the two slow-axis direction beams of the two adjacent lighting modules after passing through the collimator for the first lighting module array.

The optical apparatus in accordance with another exemplary embodiment of the invention includes a transmitting module and a receiving module. The transmitting module includes a first lighting module array, a collimator, and a reflective element at transmitting end. The first lighting module array includes a plurality of lighting modules and the lighting modules are arranged along a slow-axis direction of the lighting module. The receiving module includes a receiving lens, a first optical receiver array, and a reflective element at receiving end, and the first optical receiver array includes a plurality of optical receivers. The light beams emitted by the first lighting module array first enters and penetrates the collimator, respectively, then reflected by the reflective element at transmitting end toward an object, the object reflects the light beams toward the reflective element at receiving end, the reflective element at receiving end reflects the light beams causing the light beams entering and penetrating the receiving lens, and finally enters the first optical receiver array and received by the optical receivers.

In another exemplary embodiment, the collimator includes a first lens, the first lens is a biconvex lens with positive refractive and includes a convex surface facing the first lighting module array and another convex surface facing away from the first lighting module array, and the first lens is an aspheric lens.

In yet another exemplary embodiment, the collimator further includes a second lens disposed between the first lighting module array and the first lens, the second lens is a plano-concave lens with negative refractive power and includes a concave surface facing the first lighting module array and a plane surface facing away from the first lighting module array, and the second lens is a spherical lens.

In another exemplary embodiment, the transmitting module further includes a first prism and a second prism, the first prism is disposed between the first lighting module array and the second prism, the second prism is disposed between the first prism and the collimator, and the collimator includes a first lens, a second lens, a third lens, and a fourth lens; the first lens, the second lens, the third lens, and the fourth lens are arranged in order from an optical axis; the first lens is a meniscus lens with negative refractive power and includes a concave surface facing the first lighting module array and a convex surface facing away from the first lighting module array, and the first lens is a spherical lens; the second lens is a meniscus lens with positive refractive power and includes a concave surface facing the first lighting module array and a convex surface facing away from the first lighting module array, and the second lens is a spherical lens; the third lens is a meniscus lens with negative refractive power and includes a convex surface facing the first lighting module array and a concave surface facing away from the first lighting module array, and the third lens is a spherical lens; the fourth lens is a biconvex lens with positive refractive power and includes a convex surface facing the first lighting module array and another convex surface facing away from the first lighting module array, and the fourth lens is a spherical lens; and the third lens and the fourth lens are cemented.

In yet another exemplary embodiment, the collimator includes a first lens, a second lens, a third lens, and a fourth lens; the first lens, the second lens, the third lens, and the fourth lens are arranged in order from an optical axis; the first lens is a meniscus lens with positive refractive power and includes a convex surface facing the first lighting module array and a concave surface facing away from the first lighting module array, and the first lens is a spherical lens; the second lens is a meniscus lens with negative refractive power and includes a convex surface facing the first lighting module array and a concave surface facing away from the first lighting module array, and the second lens is a spherical lens; the third lens is a meniscus lens with positive refractive power and includes a concave surface facing the first lighting module array and a convex surface facing away from the first lighting module array, and the third lens is a spherical lens; and the fourth lens is a meniscus lens with positive refractive power and includes a convex surface facing the first lighting module array and a concave surface facing away from the first lighting module array, and the fourth lens is a spherical lens.

In another exemplary embodiment, the receiving lens includes a fifth lens, a sixth lens, and a seventh lens; the fifth lens, the sixth lens, and the seventh lens are arranged in order from an optical axis; the fifth lens is a meniscus lens with positive refractive power and includes a convex surface facing away from the first optical receiver array and a concave surface facing the first optical receiver array, and the fifth lens is a spherical lens; the sixth lens is a meniscus lens with positive refractive power and includes a convex surface facing away from the first optical receiver array and a concave surface facing the first optical receiver array, and the sixth lens is a spherical lens; and the seventh lens is a plano-concave lens with negative refractive power and includes a concave surface facing away from the first optical receiver array and a plane surface facing the first optical receiver array, and the seventh lens is a spherical lens.

In yet another exemplary embodiment, the optical apparatus further includes an optical path turning element disposed between the reflective element at transmitting end and the object, so that the light beams first reflected by the reflective element at transmitting end toward the optical path turning element, then changes the optical path through the optical path turning element toward the object, the object reflects the light beams toward the optical path turning element, then the optical path turning element changes the optical path of the light beams toward the reflective element at receiving end, and the optical path turning element is a rotatable polygon mirror or a rotatable reflective mirror.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a first embodiment of a lighting module in accordance with the invention;

FIG. 2 is a schematic diagram of the lighting module in FIG. 1 with the cylindrical optical element, cap and cover glass removed and viewed along the arrow direction A, as well as a section view IV-IV;

FIG. 3 is a partially enlarged schematic diagram of the lighting module in FIG. 1 with the cap and cover glass removed and viewed along the arrow direction C;

FIG. 4 is a schematic diagram of the optical structure in the fast-axis direction of a second embodiment of a lighting module in accordance with the invention;

FIG. 5 is a schematic diagram of the optical structure in the fast-axis direction of a transmitting module of a first embodiment of an optical apparatus in accordance with the invention;

FIG. 6 is a schematic diagram of the optical structure in the fast-axis direction of a transmitting module of a second embodiment of an optical apparatus in accordance with the invention;

FIG. 7 is a schematic diagram of the optical structure in the fast-axis direction of a transmitting module of a third embodiment of an optical apparatus in accordance with the invention;

FIG. 8 is a schematic diagram of the optical structure in the fast-axis direction of a third embodiment of a lighting module in accordance with the invention;

FIG. 9 is a schematic diagram of the optical structure in the slow-axis direction of the third embodiment of the lighting module in accordance with the invention;

FIG. 10 is a schematic diagram of the system structure in the slow-axis direction of a transmitting module of a fourth embodiment of an optical apparatus in accordance with the invention;

FIG. 11 is a schematic diagram of the system structure of a receiving module of the fourth embodiment of the optical apparatus in accordance with the invention;

FIG. 12 is a partial schematic diagram of FIG. 10;

FIG. 13 is a partial schematic diagram of FIG. 11;

FIG. 14 is an enlarged schematic diagram of FIG. 12;

FIG. 15 is a schematic diagram of the system structure in the fast-axis direction of a transmitting module of a fifth embodiment of an optical apparatus in accordance with the invention;

FIG. 16 is a schematic diagram of the system structure of a receiving module of the fifth embodiment of the optical apparatus in accordance with the invention;

FIG. 17 is a schematic diagram of the optical structure in the fast-axis direction of a transmitting module of a sixth embodiment of an optical apparatus in accordance with the invention;

FIG. 18 is a schematic diagram of the optical structure in the slow-axis direction of the transmitting module of the sixth embodiment of the optical apparatus in accordance with the invention; and

FIG. 19 is a schematic diagram of the optical structure of a receiving module of the sixth embodiment of the optical apparatus in accordance with the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a lighting module including a lighting unit, a cylindrical optical element, a supporting unit, and a base. The supporting unit connects the base and a part of the supporting unit is higher than a junction of the base and the supporting unit. The cylindrical optical element includes an incident surface and both ends of the cylindrical optical element are respectively connected to the supporting unit making the incident surface facing the lighting surface and having an interval from the lighting unit to the incident surface, and the light beam emitted by the lighting surface enters the cylindrical optical element from the incident surface. The lighting module satisfies the following condition: 2≤D/E≤6; wherein D is a diameter of the cylindrical optical element and E is the interval from the lighting unit to the incident surface.

The present invention provides an optical apparatus including a transmitting module and a receiving module. The transmitting module includes a lighting module and a collimator. The receiving module includes a receiving lens and an optical receiver. The light beam emitted by the lighting module first enters and penetrates the collimator, then enters an object and is reflected by the object, then enters and penetrates the receiving lens, and finally enters the optical receiver.

The present invention provides another optical apparatus including a transmitting module and a receiving module. The transmitting module includes a first lighting module array and a collimator, the first lighting module array includes a plurality of lighting modules and the lighting modules are arranged along a slow-axis direction of the lighting module. The lighting surfaces include respectively a center point. The receiving module includes a receiving lens and a first optical receiver array and the first optical receiver array includes a plurality of optical receivers. The light beams emitted by the first lighting module array first enters and penetrates the collimator respectively, then enters an object and is reflected by the object, then enters and penetrates the receiving lens, and finally enters the optical receivers of the first optical receiver array, respectively. The optical apparatus satisfies at least one of the following conditions: Y≤31 mm; 0.90≤Y/(2×fts×tan(ω))≤1.10; 0.90≤Y/((n−1)×L+d)≤1.10; 0.90≤H/(2×fr×tan(ω))≤1.10; wherein Y is an interval from the first lighting surface to the last lighting surface along the slow-axis direction for the first lighting module array; n is a total number of the lighting modules; L is an interval between two center points of the two lighting surfaces of the two adjacent lighting modules for the first lighting module array; d is a slow-axis length of the lighting surface; fts is an effective focal length of the lighting module in the slow-axis direction for the transmitting module; ω is a half field of view angle of the transmitting module; H is an interval from a center point of the first optical receiver to a center point of the last optical receiver for the first optical receiver array; and fr is an effective focal length of the receiving module.

The present invention provides yet another optical apparatus including a transmitting module and a receiving module. The transmitting module includes a first lighting module array, a collimator, and a reflective element at transmitting end. The first lighting module array includes a plurality of lighting modules and the lighting modules are arranged along a slow-axis direction of the lighting module. The receiving module includes a receiving lens, a first optical receiver array, and a reflective element at receiving end, and the first optical receiver array includes a plurality of optical receivers. The light beams emitted by the first lighting module array first enters and penetrates the collimator, respectively, then reflected by the reflective element at transmitting end toward an object, the object reflects the light beams toward the reflective element at receiving end, the reflective element at receiving end reflects the light beams causing the light beams entering and penetrating the receiving lens, and finally enters the first optical receiver array and received by the optical receivers.

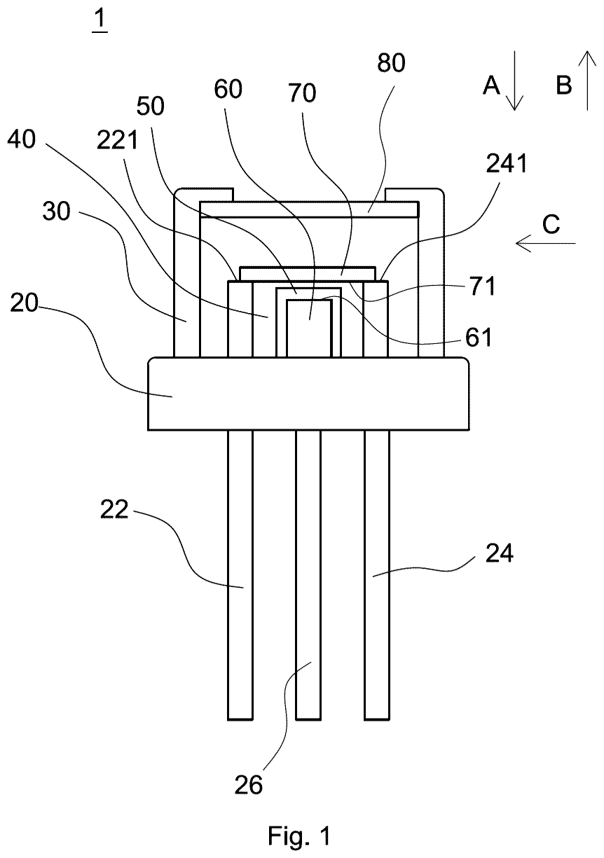

Referring to FIG. 1, FIG. 1 is a schematic diagram of a first embodiment of a lighting module in accordance with the invention. The lighting module 1 includes a base 20, a supporting unit 22, a supporting unit 24, a supporting unit 26, a cap 30, a heat sink 40, a heat sink substrate 50, a lighting unit 60, a cylindrical optical element 70, and a cover glass 80. The supporting unit 22 includes a supporting unit end face 221. The supporting unit 24 includes a supporting unit end face 241. The supporting units 22, 24, and 26 are respectively connected to the base 20, and the supporting unit end faces 221 and 241 are higher than the junction of the base 20 and the supporting units 22 and 24. The heat sink 40 is connected to the base 20. The heat sink substrate 50 is connected to the heat sink 40. The lighting unit 60 includes a lighting surface 61 and connects to the heat sink substrate 50, so that the lighting unit 60 is disposed between the supporting unit end face 221 and the supporting unit end face 241, and the lighting surface 61 and the heat sink substrate 50 are perpendicular to each other. The cylindrical optical element 70 includes an incident surface 71 facing the lighting surface 61. Two ends of the cylindrical optical element 70 are connected to the supporting unit end face 221 and the supporting unit end face 241, respectively. The base 20 is connected to the cap 30 which is covered with the cover glass 80. A light beam (not shown) emitted from the lighting surface 61 is incident on the incident surface 71 along the arrow direction B and penetrates the cylindrical optical element 70, and finally exited the lighting module 1 through the cover glass 80. The axial direction of the cylindrical optical element 70 (i.e., the horizontal direction in FIG. 1) is parallel to the slow-axis direction of the lighting unit 60 (i.e., the horizontal direction in FIG. 1) and is perpendicular to the fast-axis direction of the lighting unit 60 (i.e., the vertical direction in FIG. 1). When the light beam passes through the cylindrical optical element 70, the divergence angle of the light beam in the fast-axis direction is compressed, so that the light beam in the fast-axis direction is concentrated to improve the collimation of the light beam in the fast-axis direction. As for the divergence angle of the light beam in the slow-axis direction remains unchanged.

The cylindrical optical element 70 of the above-mentioned lighting module 1 is fixed on the supporting unit end face 221 and the supporting unit end face 241, which can greatly reduce the assembly time of the cylindrical optical element 70, and the optical axis (i.e., the center line of the light beam) is consistent with the structural center line of the lighting module 1, which is beneficial to the optical axis calibration for the optical apparatus.

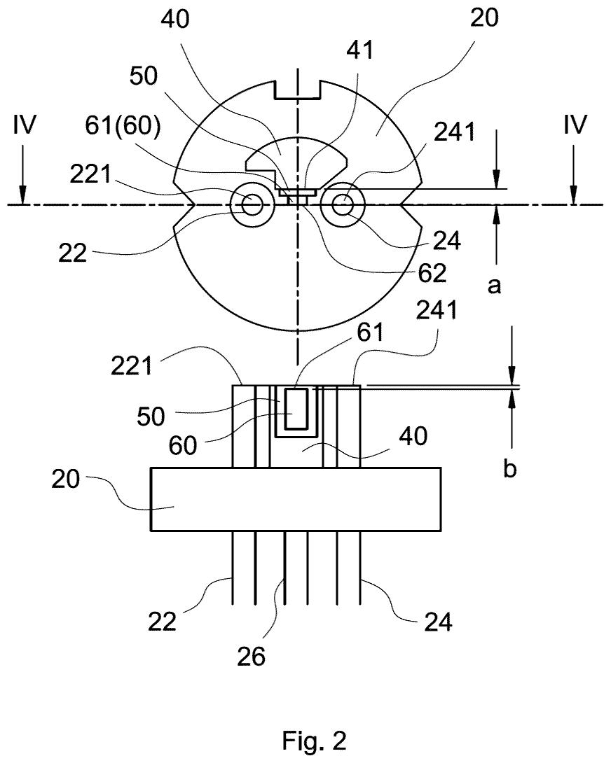

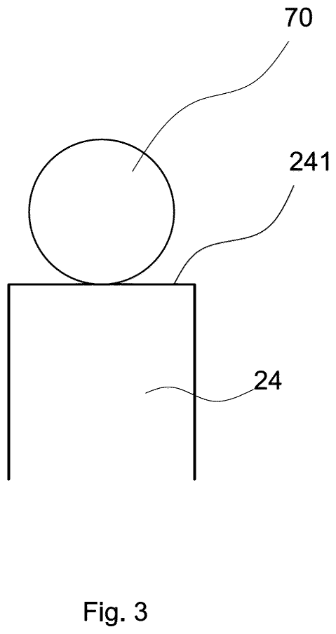

The assembly process of the lighting module 1 will be further described below. Please refer to FIG. 2 and FIG. 3 at the same time. FIG. 2 is a schematic diagram of the lighting module in FIG. 1 with the cylindrical optical element, cap and cover glass removed and viewed along the arrow direction A (i.e., from top to bottom), as well as a section view IV-IV. FIG. 3 is a partially enlarged schematic diagram of the lighting module in FIG. 1 with the cap and cover glass removed and viewed along the arrow direction C (i.e., from right to left). First, selecting the base 20 as shown in the upper half of FIG. 2, wherein the interval from the line connecting the center point of the supporting unit end face 221 and the center point of the supporting unit end face 241 to the bonding surface 41 of the heat sink 40 is a. Then, selecting a heat sink substrate 50 with a suitable thickness and fixing the heat sink substrate 50 with the bonding surface 41 of the heat sink 40 and the lighting unit 60, respectively, making the upper surface 62 of the lighting unit 60 aligned with the line connecting the center point of the supporting unit end surface 221 and the center point of the supporting unit end surface 241, and the vertical interval from the center point (not shown) of the lighting surface 61 to the line connecting the center point of the supporting unit end surface 221 and the center point of the supporting unit end surface 241 is b (as shown in the lower half of FIG. 2). In this embodiment, the optimal value of b is approximately 30 μm. Finally, the two ends of the cylindrical optical element 70 are respectively fixed on the supporting unit end surface 221 and the supporting unit end surface 241. When the cap 20 and the cover glass 80 are removed from the lighting module 1 in FIG. 1 and the cylindrical optical element 70 is a rod lens, a partial enlarged schematic diagram as shown in FIG. 3 can be viewed visually along the arrow direction C. In this embodiment, the lighting module 1 is a preferred embodiment of the lighting module of the present invention when it satisfies the following condition (1):

$$2 \leq D / E \leq 6 ; \qquad ( 1 )$$

wherein D is a diameter of the cylindrical optical element and E is the interval from the lighting unit to the incident surface. The lighting module 1 is one of the best embodiments of the lighting module of the present invention when it further satisfies the following condition (2): 4≤D/E≤5. In this embodiment, the diameter of the cylindrical optical element 70 is 134 μm, the length is 1.26 mm, and b is 30 μm. It can be obtained that D/E=134/30≈4.47 satisfying condition (1) and further satisfying condition (2), so that the lighting module 1 is one of the best embodiments of the lighting module of the present invention. The lighting module 1 can compress the fast-axis direction divergence angle of the light beam from 40 degrees to 7 degrees.

The above-mentioned lighting unit 60 is a laser diode chip, the cylindrical optical element 70 can be a rod lens, a cylindrical lens, an optical fiber, or a fast-axis collimating lens. The parameter E of condition (1) is the back focal length B of the cylindrical optical element. When the cylindrical optical element is a bare optical fiber which is without fiber coating, the back focal length B of the bare optical fiber with different diameters (i.e., outer diameter) D can be calculated theoretically. Table 1 shows the data for bare optical fiber diameter D, back focal length B, and the ratio of bare optical fiber diameter D to back focal length B. It can be seen from Table 1 that the ratio of bare optical fiber diameter D to back focal length B is approximately between 2 and 6.

TABLE 1

| Bare Optical Fiber Diameter D | Back Focal Length B | |
|---|---|---|
| (mm) | (mm) | D/B |
| 1.0 | 0.19 | 5.24 |
| 0.40 | 0.07 | 5.56 |
| 0.13 | 0.02 | 5.16 |
| 0.14 | 0.03 | 5.17 |
| 0.10 | 0.04 | 2.59 |
| 0.050 | 0.01 | 3.68 |

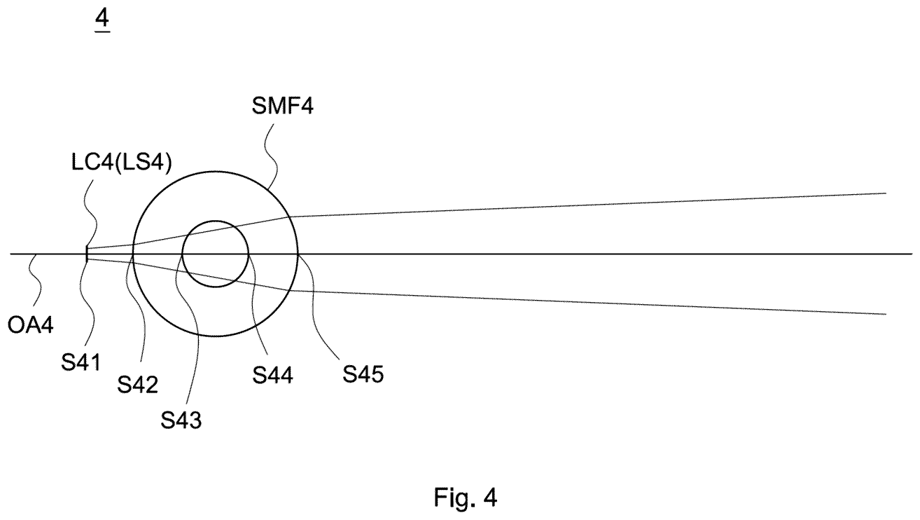

Referring to FIG. 4, FIG. 4 is a schematic diagram of the optical structure in the fast-axis direction of a second embodiment of a lighting module in accordance with the invention. The lighting module 4 includes a lighting unit LC4 and a single mode optical fiber SMF4, both of which are arranged in order along an optical axis OA4. The lighting unit LC4 includes a lighting surface LS4. The fast-axis direction of the lighting unit LC4 is the vertical direction in FIG. 4, the slow-axis direction is the normal incidence direction in FIG. 4, the axial direction of the single mode optical fiber SMF4 (i.e., the normal incidence direction of FIG. 4) is parallel to the slow-axis direction of the lighting unit LC4 of the lighting module 4 (i.e., the normal incidence direction of FIG. 4), and perpendicular to the fast-axis direction of the lighting unit LC4 of the lighting module 4 (i.e., the vertical direction of FIG. 4). The light beam is emitted from the lighting surface LS4 and then enters and penetrates the single mode optical fiber SMF4. The divergence angle of the fast-axis direction light beam is compressed after the fast-axis direction light beam penetrates the single mode optical fiber SMF4, so that the fast-axis direction light beam is concentrated and the collimation of the fast-axis direction light beam is improved. As for the divergence angle of the slow-axis direction light beam remains unchanged. Table 2 shows the optical simulation data for the above-mentioned lighting module 4 in the fast-axis direction. It can be seen from Table 2 that D=0.124 mm, E=0.03 mm, D/E=0.124/0.03≈4.13, that is, the lighting module 4 satisfies the condition (1) and further satisfies condition (2), so that the lighting module 4 is one of the best embodiments of the present invention.

TABLE 2

| | | | Fast-axis | | | | |
|---|---|---|---|---|---|---|---|
| | | | Light | | | | |
| | | | Beam | | | Effective | |
| | Radius of | | Effective | | | Focal | |
| Surface | Curvature | Interval | Diameter | | | Length | |
| Number | (mm) | (mm) | (mm) | Nd | Vd | (mm) | Remark |
| S41 | ∞ | 0.03 | 0.01 | | | | LS4 |
| S42 | 0.063 | 0.037 | 0.011 | 1.4740 | 65.3864 | 0.094 | SMF4 |
| S43 | 0.025 | 0.05 | 0.028 | 1.4875 | 65.8072 | | |
| S44 | −0.025 | 0.037 | 0.041 | 1.4740 | 65.3864 | | |
| S45 | −0.063 | 6.264 | 0.056 | | | | |

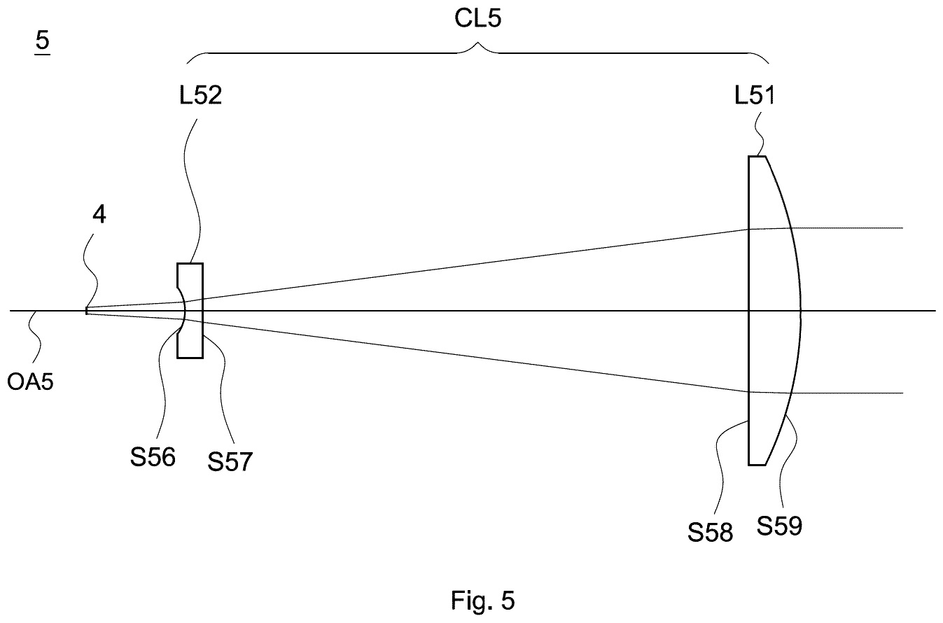

Referring to FIG. 5, FIG. 5 is a schematic diagram of the optical structure in the fast-axis direction of a transmitting module of a first embodiment of an optical apparatus in accordance with the invention. The first embodiment of the optical apparatus includes a transmitting module 5 and a receiving module (not shown). The transmitting module 5 emits a light beam toward an object (not shown) and the object (not shown) reflects the light beam toward the receiving module (not shown). The transmitting module 5 includes a lighting module 4 as shown in FIG. 4 and a collimator CL5, both of which are arranged in order along an optical axis OA5. The collimator CL5 includes a second lens L52 and a first lens L51, both of which are arranged in order along the optical axis OA5. The second lens L52 is a plano-concave lens with negative refractive power and includes a concave surface S56 facing the lighting module 4 and a plane surface facing away from the lighting module 4, wherein the concave surface S56 is a spherical surface. The first lens L51 is a biconvex lens with positive refractive power and includes a convex surface S58 facing the lighting module 4 and another convex surface S59 facing away from the lighting module 4, wherein the convex surface S58 is a spherical surface and the convex surface S59 is an aspheric surface. The receiving module (not shown) includes a receiving lens (not shown) and an optical receiver (not shown). The light beam is emitted by the lighting module 4. The divergence angle of the fast-axis direction light beam is compressed, so that the fast-axis direction light beam is concentrated and the collimation of the fast-axis direction light beam is improved. As for the divergence angle of the slow-axis direction light beam remains unchanged. Then, the light beam enters and penetrates the collimator CL5 further compressing the divergence angle of the light beam. Table 3 shows the optical simulation data for the above-mentioned transmitting module 5 in the fast-axis direction.

TABLE 3
Effective Focal Length: 53.209 mm

| | | | Fast-axis | | | | |
|---|---|---|---|---|---|---|---|
| | | | Light | | | | |
| | | | Beam | | | Effective | |
| | Radius of | | Effective | | | Focal | |
| Surface | Curvature | Interval | Diameter | | | Length | |
| Number | (mm) | (mm) | (mm) | Nd | Vd | (mm) | Remark |
| S51 | ∞ | 0.03 | 0.01 | | | | LS4 |
| S52 | 0.063 | 0.037 | 0.011 | 1.4740 | 65.3864 | 0.094 | SMF4 |
| S53 | 0.025 | 0.05 | 0.028 | 1.4875 | 65.8072 | | |
| S54 | −0.025 | 0.037 | 0.041 | 1.4740 | 65.3864 | | |
| S55 | −0.063 | 6.264 | 0.056 | | | | |
| S56 | −2.25 | 1.1 | 1.3 | 1.5168 | 64.1987 | −4.42 | L52 |
| S57 | ∞ | 34.42 | 1.7 | | | | |
| S58 | 1000 | 3.5 | 19.59 | 1.5891 | 61.1526 | 39.931 | L51 |
| S59 | −23.671 | ∞ | 20 | | | | |

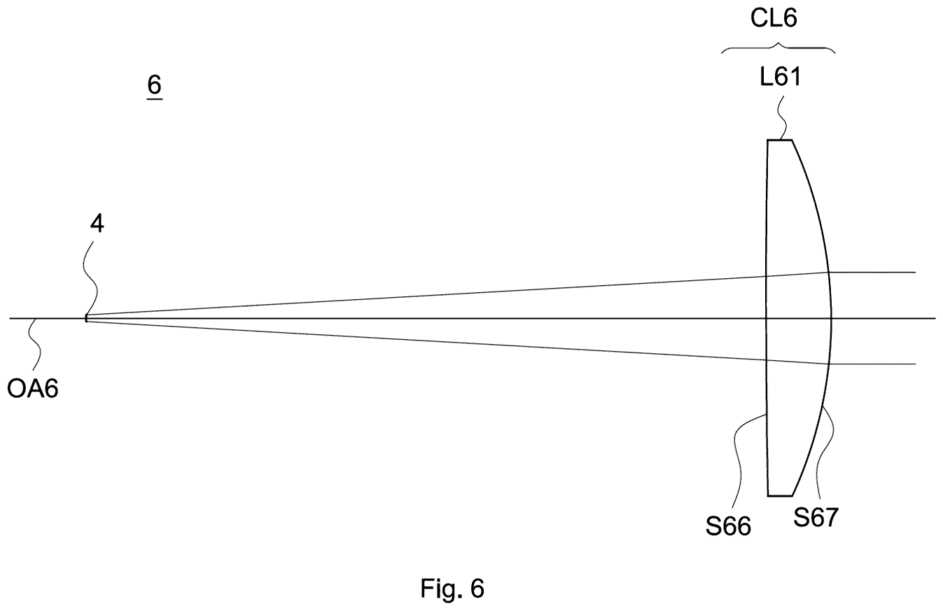

Referring to FIG. 6, FIG. 6 is a schematic diagram of the optical structure in the fast-axis direction of a transmitting module of a second embodiment of an optical apparatus in accordance with the invention. The second embodiment of the optical apparatus includes a transmitting module 6 and a receiving module (not shown). The transmitting module 6 emits a light beam toward an object (not shown) and the object (not shown) reflects the light beam toward the receiving module (not shown). The transmitting module 6 includes a lighting module 4 as shown in FIG. 4 and a collimator CL6, both of which are arranged in order along an optical axis OA6. The collimator CL6 includes a first lens L61. The first lens L61 is a biconvex lens with positive refractive power and includes a convex surface S66 facing the lighting module 4 and another convex surface S67 facing away from the lighting module 4, wherein the convex surface S66 is a spherical surface and the convex surface S67 is an aspheric surface. The receiving module (not shown) includes a receiving lens (not shown) and an optical receiver (not shown). The light beam is emitted by the lighting module 4. The divergence angle of the fast-axis direction light beam is compressed, so that the fast-axis direction light beam is concentrated and the collimation of the fast-axis direction light beam is improved. As for the divergence angle of the slow-axis direction light beam remains unchanged. Then, the light beam enters and penetrates the collimator CL6 further compressing the divergence angle of the light beam. Table 4 shows the optical simulation data for the above-mentioned transmitting module 6 in the fast-axis direction.

TABLE 4
Effective Focal Length: 11.4255 mm

| | | | Fast-axis | | | | |
|---|---|---|---|---|---|---|---|
| | | | Light | | | | |
| | | | Beam | | | Effective | |
| | Radius of | | Effective | | | Focal | |
| Surface | Curvature | Interval | Diameter | | | Length | |
| Number | (mm) | (mm) | (mm) | Nd | Vd | (mm) | Remark |
| S61 | ∞ | 0.03 | 0.01 | | | | LS4 |
| S62 | 0.063 | 0.037 | 0.011 | 1.4740 | 65.3864 | 0.094 | SMF4 |
| S63 | 0.025 | 0.05 | 0.028 | 1.4875 | 65.8072 | | |
| S64 | −0.025 | 0.037 | 0.041 | 1.4740 | 65.3864 | | |
| S65 | −0.063 | 37.469 | 0.056 | | | | |
| S66 | 1000 | 3.5 | 19.59 | 1.5891 | 61.1526 | 39.931 | L61 |
| S67 | −23.671 | ∞ | 20 | | | | |

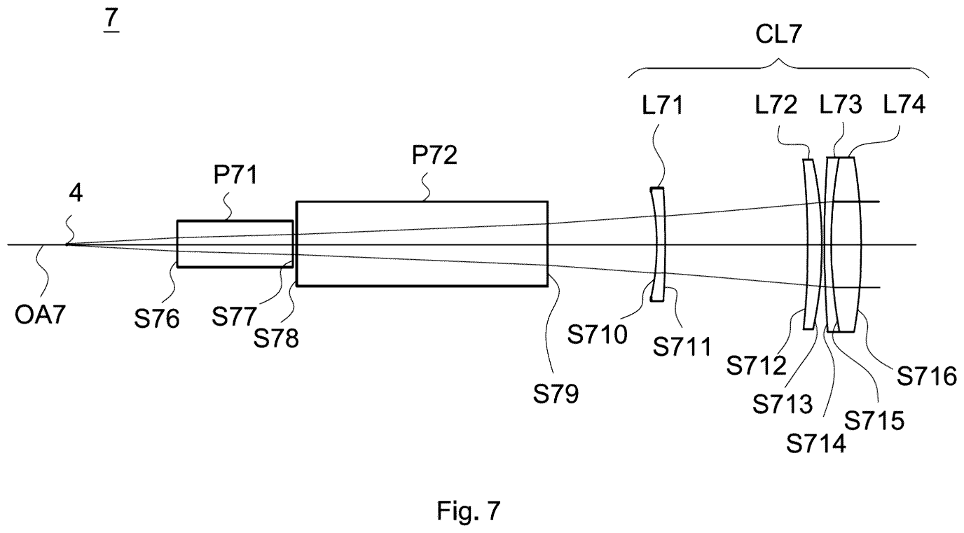

Referring to FIG. 7, FIG. 7 is a schematic diagram of the optical structure in the fast-axis direction of a transmitting module of a third embodiment of an optical apparatus in accordance with the invention. The third embodiment of the optical apparatus includes a transmitting module 7 and a receiving module (not shown). The transmitting module 7 emits a light beam toward an object (not shown) and the object (not shown) reflects the light beam toward the receiving module (not shown). The transmitting module 7 includes a lighting module 4 as shown in FIG. 4, a first prism P71, a second prism P72, and a collimator CL7, all of which are arranged in order along an optical axis OA7. The collimator CL7 includes a first lens L71, a second lens L72, a third lens L73, and a fourth lens L74, all of which are arranged in order along the optical axis OA7. The first lens L71 is a meniscus lens with negative refractive power and includes a concave surface S710 facing the lighting module 4 and a convex surface S711 facing away from the lighting module 4, wherein the concave surface S710 is a spherical surface and the convex surface S711 is a spherical surface. The second lens L72 is a meniscus lens with positive refractive power and includes a concave surface S712 facing the lighting module 4 and a convex surface S713 facing away from the lighting module 4, wherein the concave surface S712 is a spherical surface and the convex surface S713 is a spherical surface. The third lens L73 is a meniscus lens with negative refractive power and includes a convex surface S714 facing the lighting module 4 and a concave surface S715 facing away from the lighting module 4, wherein the convex surface S714 is a spherical surface and the concave surface S715 is a spherical surface. The fourth lens L74 is a biconvex lens with positive refractive power and includes a convex surface S715 facing the lighting module 4 and another convex surface S716 facing away from the lighting module 4, wherein the convex surface S715 is a spherical surface and the convex surface S716 is a spherical surface. The third lens L73 and the fourth lens L74 are cemented. The receiving module (not shown) includes a receiving lens (not shown) and an optical receiver (not shown). The light beam is emitted by the lighting module 4. The divergence angle of the fast-axis direction light beam is compressed, so that the fast-axis direction light beam is concentrated and the collimation of the fast-axis direction light beam is improved. As for the divergence angle of the slow-axis direction light beam remains unchanged. Then, the light beam enters and penetrates the first prism P71 and the second prism P72, then incident on the collimator CL7 further compressing the divergence angle of the light beam. Table 5 shows the optical simulation data for the above-mentioned transmitting module 7 in the fast-axis direction.

TABLE 5
Effective Focal Length: 49.77 mm

| | | | Fast-axis | | | | |
|---|---|---|---|---|---|---|---|
| | | | Light | | | | |
| | | | Beam | | | Effective | |
| | Radius of | | Effective | | | Focal | |
| Surface | Curvature | Interval | Diameter | | | Length | |
| Number | (mm) | (mm) | (mm) | Nd | Vd | (mm) | Remark |
| S71 | ∞ | 0.027 | 0.01 | | | | LS4 |
| S72 | 0.063 | 0.038 | 0.01 | 1.4740 | 65.3864 | 0.094 | SMF4 |
| S73 | 0.025 | 0.05 | 0.027 | 1.4875 | 65.8072 | | |
| S74 | −0.025 | 0.038 | 0.041 | 1.4740 | 65.3864 | | |
| S75 | −0.063 | 26.37 | 0.057 | | | | |
| S76 | ∞ | 27.37 | 6.48 | 1.5688 | 56.0413 | | P71 |
| S77 | ∞ | 0.8 | 10.76 | | | | |
| S78 | ∞ | 59.71 | 15.2 | 1.5688 | 56.0413 | | P72 |
| S79 | ∞ | 25.75 | 20.28 | | | | |
| S710 | −70.67 | 2.13 | 26.27 | 1.7433 | 49.2218 | −180.332 | L71 |
| S711 | −151.4 | 33.91 | 27.1 | | | | |
| S712 | −203 | 3.14 | 40.19 | 1.8040 | 46.5745 | 210.162 | L72 |
| S713 | −92.85 | 0.8 | 40.76 | | | | |
| S714 | 278.38 | 1.5 | 41.5 | 1.7552 | 27.5300 | −252.590 | L73 |
| S715 | 112.93 | 7 | 41.63 | 1.4970 | 81.6054 | 118.466 | L74 |
| S716 | −120.48 | ∞ | | | | | |

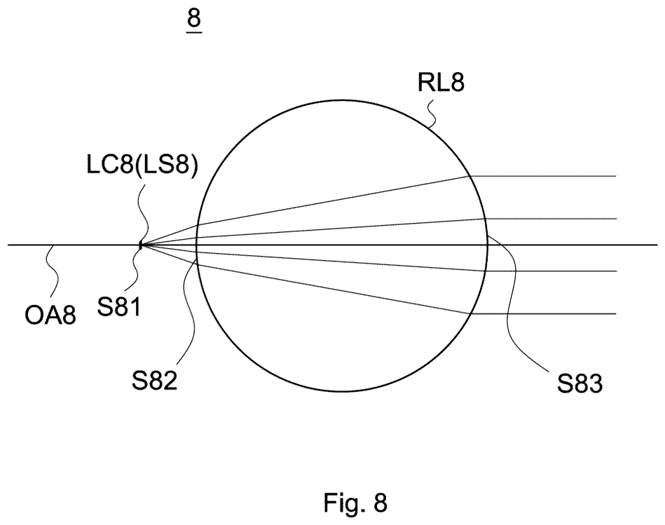

Referring to FIG. 8, FIG. 8 is a schematic diagram of the optical structure in the fast-axis direction of a third embodiment of a lighting module in accordance with the invention. The lighting module 8 includes a lighting unit LC8 and a rod lens RL8, both of which are arranged in order along an optical axis OA8. The lighting unit LC8 includes a lighting surface LS8. The fast-axis direction of the lighting unit LC8 is the vertical direction in FIG. 8, the slow-axis direction is the normal incidence direction in FIG. 8, the axial direction of the rod lens RL8 (i.e., the normal incidence direction of FIG. 8) is parallel to the slow-axis direction of the lighting unit LC8 of the lighting module 8 (i.e. the normal incidence direction of FIG. 8), and perpendicular to the fast-axis direction of the lighting unit LC8 of the lighting module 8 (i.e. the vertical direction of the FIG. 8). The light beam is emitted from the lighting surface LS8 and then enters and penetrates the rod lens RL8. The divergence angle of the fast-axis direction light beam is compressed after the fast-axis direction light beam penetrates the rod lens RL8, so that the fast-axis direction light beam is concentrated and the collimation of the fast-axis direction light beam is improved. The lighting module 8 satisfies the following condition: 2≤D/E≤6; wherein D is a diameter of the cylindrical optical element, that is, the diameter of the rod lens RL8, and E is an interval from the lighting unit to the incident surface, that is, the interval from the surface S81 to the surface S82. Table 6 shows the optical simulation data for the above-mentioned lighting module 8 in the fast-axis direction. It can be seen from Table 6 that D=0.4 mm, E=0.0076 mm, D/E=0.4/0.076≈5.26, that is, the lighting module 8 satisfies the condition: 2≤D/E≤6.

In another lighting module embodiment, one cylindrical optical element can correspond to one or more lighting units. A row of lighting module can be adjusted to share one rod lens according to the assembly accuracy and assembly cost. In other words, multiple lighting units LC8 share one rod lens RL8. For example, two lighting units LC8 share one rod lens RL8 and is not limited thereto. 16 pieces of lighting unit LC8 are first mounted on the PCB and 8 pieces of cylindrical optical element are adjusted and fixed on the PCB with glue.

TABLE 6

| R1C1 | R1C2 | R1C3 | R1C41 | R1C5 | R1C6 | R1C7 | R1C8 | R1C9 |
|---|---|---|---|---|---|---|---|---|
| S81 | ∞ | 0.076 | 0.01 | | | | | LS8 |
| S82 | 0.2 | 0.4 | 0.07 | 0.4 | 1.5168 | 64.1987 | 0.293 | RL8 |
| S83 | −0.2 | 3 | 0.2 | 0.4 | | | | |

R1C1: Surface Number
R1C2: Radius of Curvature (mm)
R1C3: Interval (mm)
R1C41: Fast-axis Light Beam Effective Diameter (mm)
R1C5: Lens Fast-axis Outer Diameter
R1C6: Nd
R1C7: Vd
R1C8: Effective Focal Length (mm)
R1C9: Remark

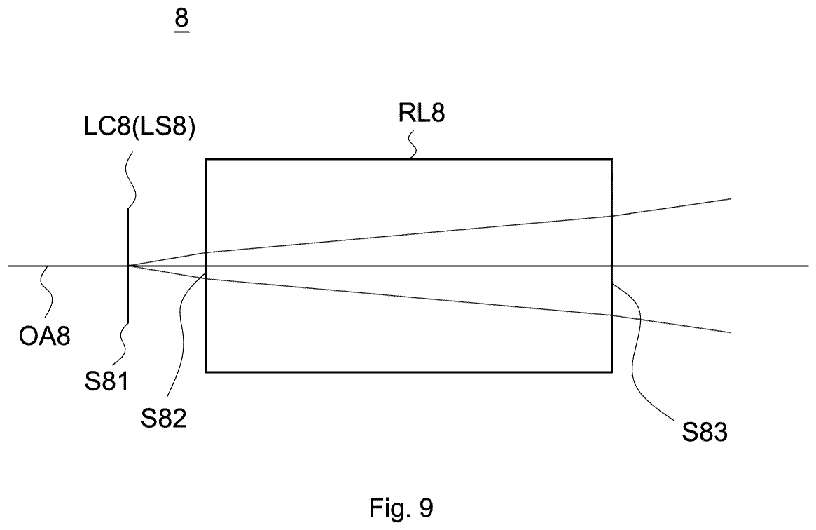

Referring to FIG. 9, FIG. 9 is a schematic diagram of the optical structure in the slow-axis direction of the third embodiment of the lighting module in accordance with the invention. The slow-axis direction of the lighting unit LC8 is the vertical direction in FIG. 9, the fast-axis direction is the normal incidence direction in FIG. 9, the axial direction of the rod lens RL8 (i.e., the vertical direction of FIG. 9) is parallel to the slow-axis direction of the lighting unit LC8 of the lighting module 8 (i.e. the vertical direction of FIG. 9), and perpendicular to the fast-axis direction of the lighting unit LC8 of the lighting module 8 (i.e., the normal incidence direction of FIG. 8). The light beam is emitted from the lighting surface LS8 and then enters and penetrates the rod lens RL8. The divergence angle of the slow-axis direction light beam does not change. Table 7 shows the optical simulation data for the above-mentioned lighting module 8 in the slow-axis direction.

TABLE 7

| R1C1 | R1C2 | R1C3 | R1C42 | R1C5 | R1C6 | R1C7 | R1C8 | R1C9 |
|---|---|---|---|---|---|---|---|---|
| S81 | ∞ | 0.076 | 0.11 | | | | | LS8 |
| S82 | ∞ | 0.4 | 0.13 | 0.4 | 1.5168 | 64.1987 | | RL8 |
| S83 | ∞ | 3 | 0.18 | 0.4 | | | | |

R1C1: Surface Number
R1C2: Radius of Curvature (mm)
R1C3: Interval (mm)
R1C42: Slow-axis Light Beam Effective Diameter (mm)
R1C5: Lens Slow-axis Outer Diameter
R1C6: Nd
R1C7: Vd
R1C8: Effective Focal Length (mm)
R1C9: Remark

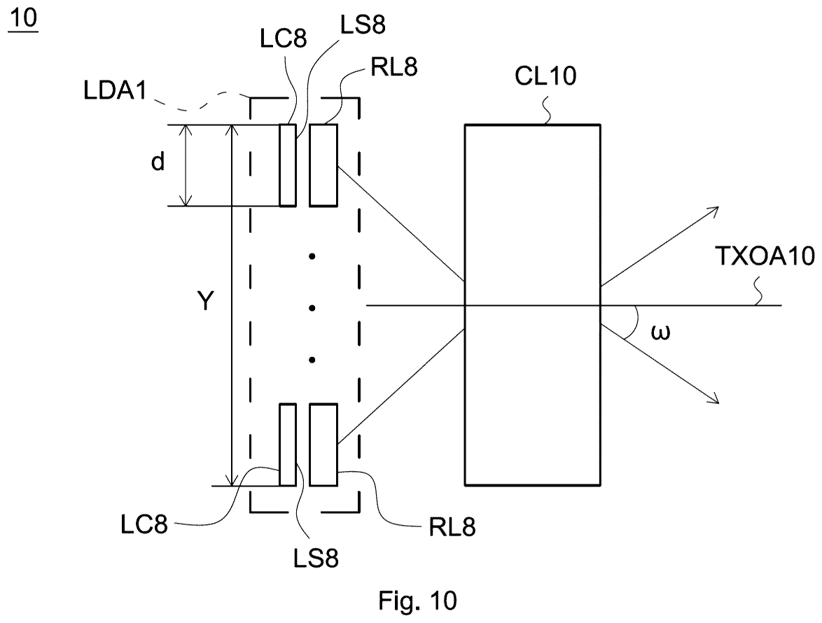

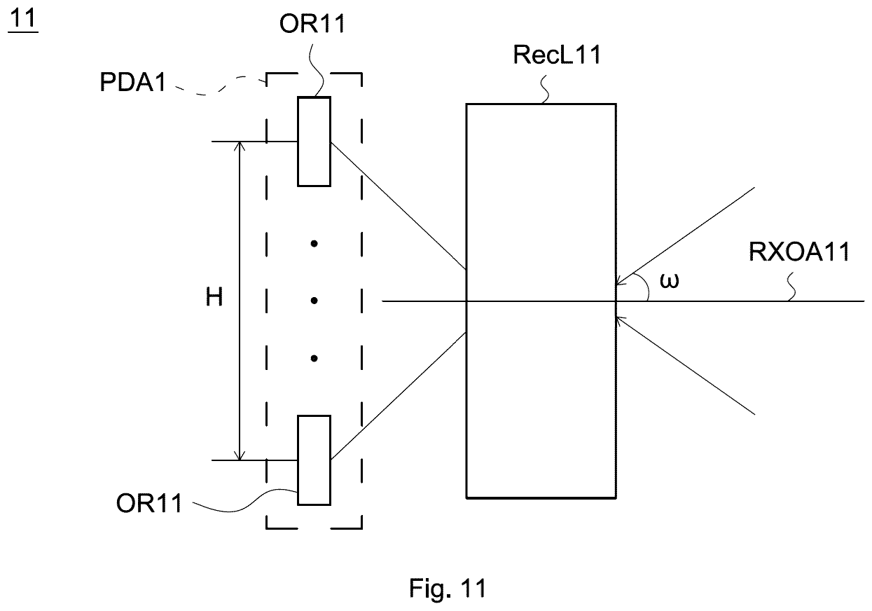

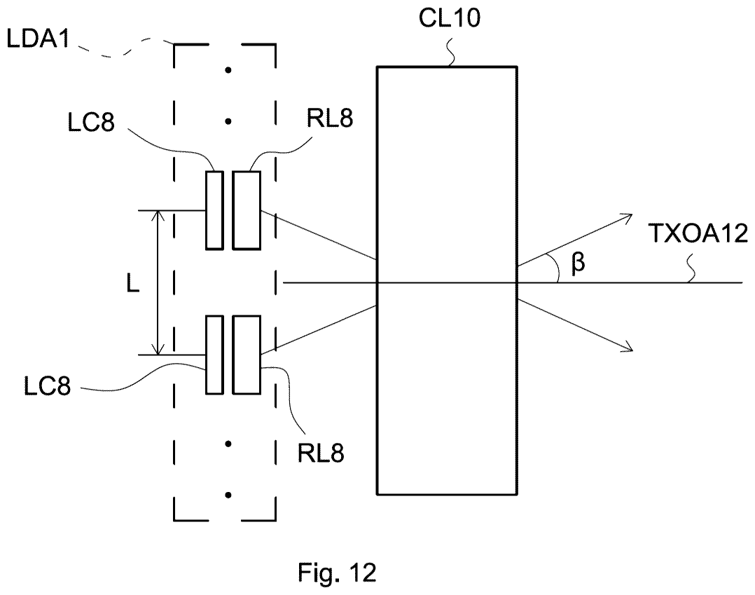

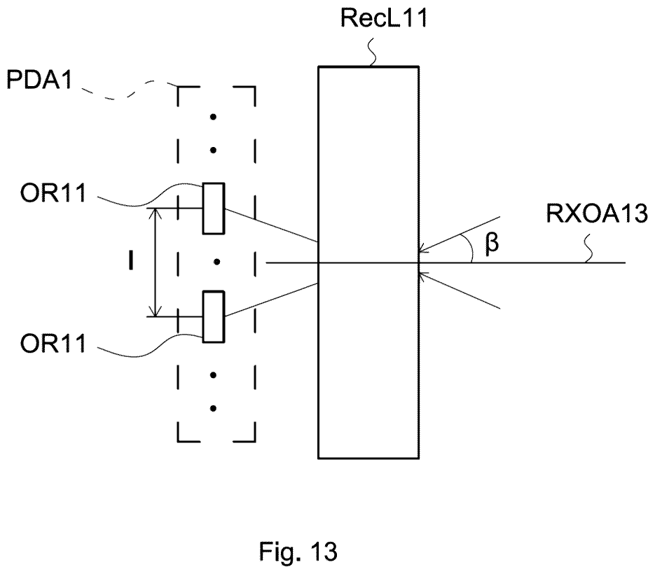

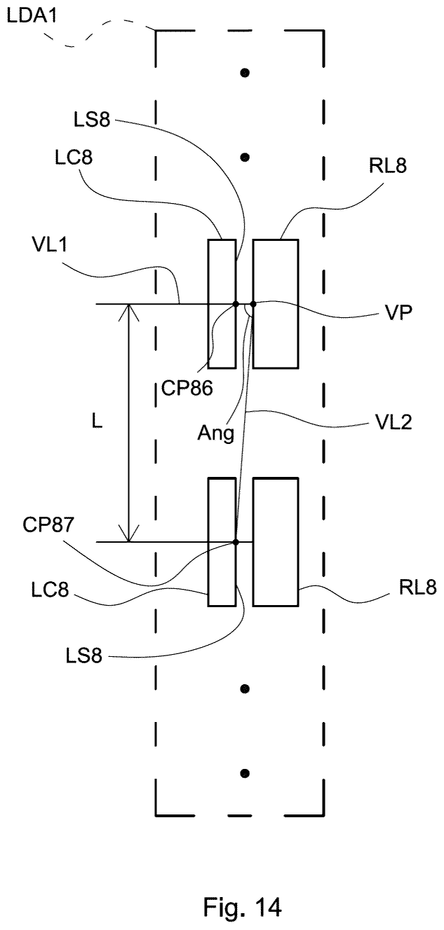

Referring to FIG. 10, FIG. 11, FIG. 12, FIG. 13, and FIG. 14, wherein FIG. 10 is a schematic diagram of the system structure in the slow-axis direction of a transmitting module of a fourth embodiment of an optical apparatus in accordance with the invention, FIG. 11 is a schematic diagram of the system structure of a receiving module of the fourth embodiment of the optical apparatus in accordance with the invention, FIG. 12 is a partial schematic diagram of FIG. 10, FIG. 13 is a partial schematic diagram of FIG. 11, and FIG. 14 is an enlarged schematic diagram of FIG. 12. The fourth embodiment of the optical apparatus includes a transmitting module 10 and a receiving module 11. The transmitting module 10 emits a light beam toward an object (not shown) and the object (not shown) reflects the light beam toward the receiving module 11. The transmitting module 10 includes a first lighting module array LDA1 and a collimator CL10. The first lighting module array LDA1 includes 16 pieces of lighting module 8 as shown in FIG. 8. The 16 pieces of lighting module 8 are arranged in a straight line at equal interval, so that the straight line direction is the connection direction of the slow axis-direction of each lighting module 8 (vertical direction in FIG. 10). The receiving module 11 includes a first optical receiver array PDA1 and a receiving lens RecL11. The first optical receiver array PDA1 includes 16 pieces of optical receiver OR11. The 16 pieces of optical receiver OR11 are arranged in a straight line at equal interval. The interval from the first lighting surface to the last lighting surface along the slow-axis direction for the first lighting module array LDA1 is Y (refer to FIG. 10), the slow-axis length of the lighting surface is d (refer to FIG. 10), the effective focal length of the laser diode in the slow-axis direction for the transmitting module 10 is fts, the half field of view angle of the transmitting module 10 is ω (refer to FIG. 10), the interval between two center points of the two lighting surfaces of the two adjacent lighting module for the first lighting module array LDA1 is L (refer to FIG. 12), the half of the angle between the two slow-axis direction beams of the two adjacent lighting modules after passing through the collimator CL10 for the first lighting module array LDA1 is β (refer to FIG. 12), the interval from the center point of the first optical receiver to the center point of the last optical receiver for the first optical receiver array PDA1 is H (refer to FIG. 11), the effective focal length of the receiving module 11 is fr, the total number of the lighting modules 8 is n, the interval between two center points of the two adjacent optical receivers OR11 for the first optical receiver array PDA1 is I (refer to FIG. 13), the first virtual line VL1 is a straight line perpendicular to surface LS8 and passes through its center point CP86 and connects the incident surface to the virtual point VP (refer to FIG. 14), the second virtual line VL2 is a straight line connects the center point CP87 of adjacent lighting surface LS8 and the virtual point VP (refer to FIG. 14), the angle between the first virtual line VL1 and the second virtual line VL2 is Ang (refer to FIG. 14). The fourth embodiment of the optical apparatus satisfies at least one of the following conditions:

$$Y \leq 31 mm ; \qquad ( 3 )$$

$$0.9 \leq Y / ( 2 \times fts \times tan ( ω ) ) \leq 1 \text{.10} ; \qquad ( 4 )$$

$$0.9 \leq Y / ( ( n - 1 ) \times L + d ) \leq 1 \text{.10} ; \qquad ( 5 )$$

$$0.9 \leq H / ( 2 \times fr \times tan ( ω ) ) \leq 1 \text{.10} ; \qquad ( 6 )$$

$$0.9 \leq L / ( 2 \times fts \times tan ( β ) ) \leq 1 \text{.10} ; \qquad ( 7 )$$

$$0.9 \leq ω / ( n \times β ) \leq 1 \text{.10} ; \qquad ( 8 )$$

$$0.9 \leq I / ( 2 \times fr \times tan ( β ) ) \leq 1 \text{.10} ; \qquad ( 9 )$$

$$45 degrees \leq Ang \leq 89 degrees ; \qquad ( 10 )$$

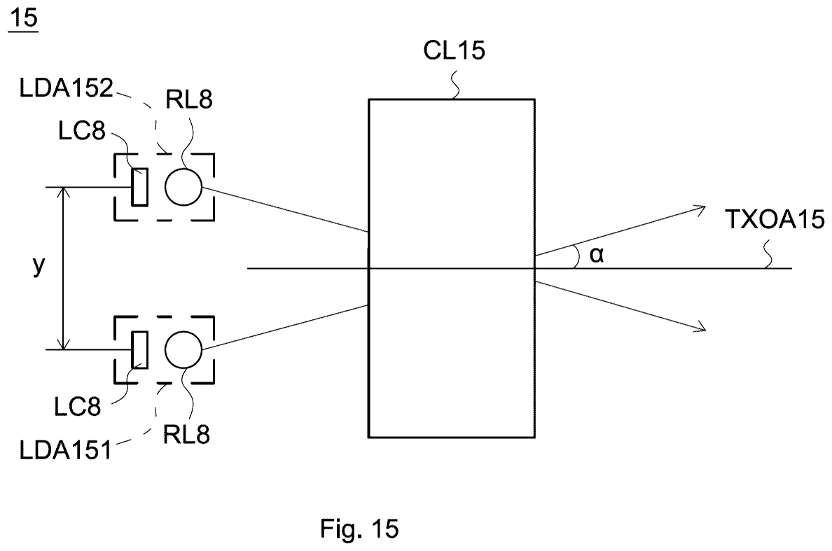

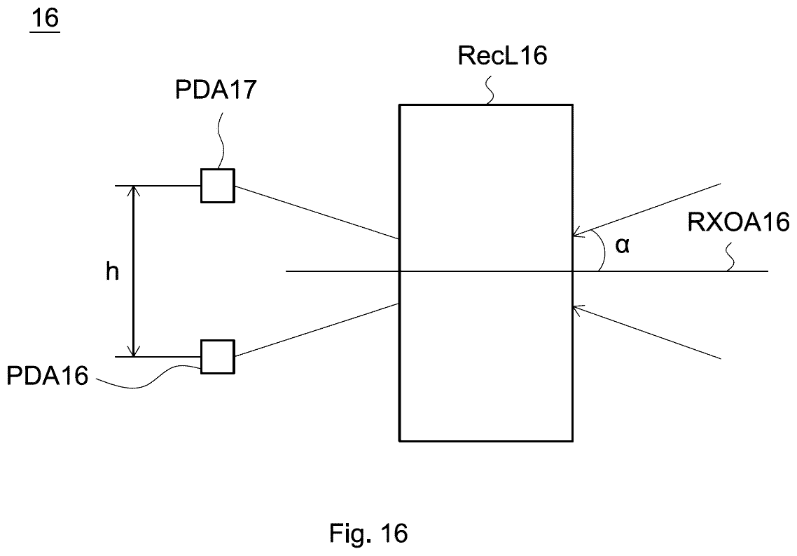

Referring to FIG. 15 and FIG. 16, wherein FIG. 15 is a schematic diagram of the system structure in the fast-axis direction of a transmitting module of a fifth embodiment of an optical apparatus in accordance with the invention and FIG. 16 is a schematic diagram of the system structure of a receiving module of the fifth embodiment of the optical apparatus in accordance with the invention. The fifth embodiment of the optical apparatus includes a transmitting module 15 and a receiving module 16. The transmitting module 15 emits a light beam toward an object (not shown) and the object (not shown) reflects the light beam toward the receiving module 16. The transmitting module 15 includes a first lighting module array LDA151, a second lighting module array LDA152, and a collimator CL15. The first lighting module array LDA151 and the second lighting module array LDA152 can be the first lighting module array LDA1 as shown in FIG. 10. The first lighting module array LDA151 and the second lighting module array LDA152 are arranged on both sides of an optical axis TXOA15, wherein the optical axis TXOA15 is the symmetrical center. The receiving module 16 includes a first optical receiver array PDA16, a second optical receiver array PDA17, and a receiving lens RecL16. The first optical receiver module PDA16 and the second optical receiver array PDA17 can be the first optical receiver array PDA1 as shown in FIG. 11. The first optical receiver array PDA16 and the second optical receiver array PDA17 are arranged on both sides of an optical axis RXOA16, wherein the optical axis RXOA16 is the symmetrical center. The interval from the center of the first lighting module array LDA151 to the center of the second lighting module array LDA152 is y (refer to FIG. 15), the effective focal length of the lighting module in the slow-axis direction for the transmitting module 15 is fts, the half of the angle between the two fast-axis direction beams of the two closest lighting modules after passing through the collimator CL15 for the first lighting module array LDA151 and the second lighting module array LDA152 is α (refer to FIG. 15), the interval from the center point of the first optical receiver array PDA16 to the center point of the second optical receiver array PDA17 is h (refer to FIG. 16), the effective focal length of the receiving module 5 is fr, the definition of β is the same as β in FIG. 12. The fifth embodiment of the optical apparatus satisfies at least one of the following conditions:

$$0.90 \leq y / ( 2 \times fts \times tan ( α ) ) \leq 1.1 ; \qquad ( 11 )$$

$$0.9 \leq h / ( 2 \times fr \times tan ( α ) ) \leq 1.1 ; \qquad ( 12 )$$

$$1.71 \leq α / β \leq 1.89 ; \qquad ( 13 )$$

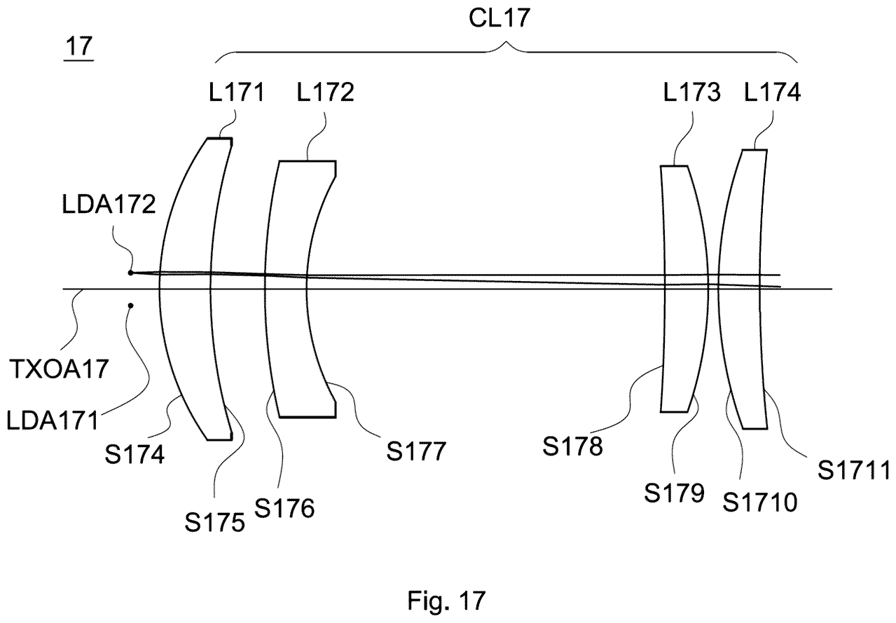

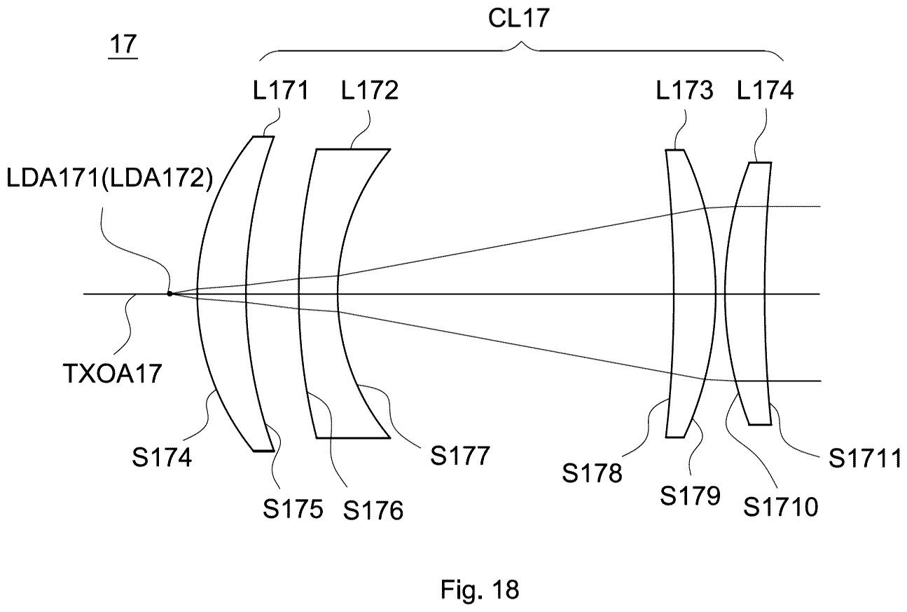

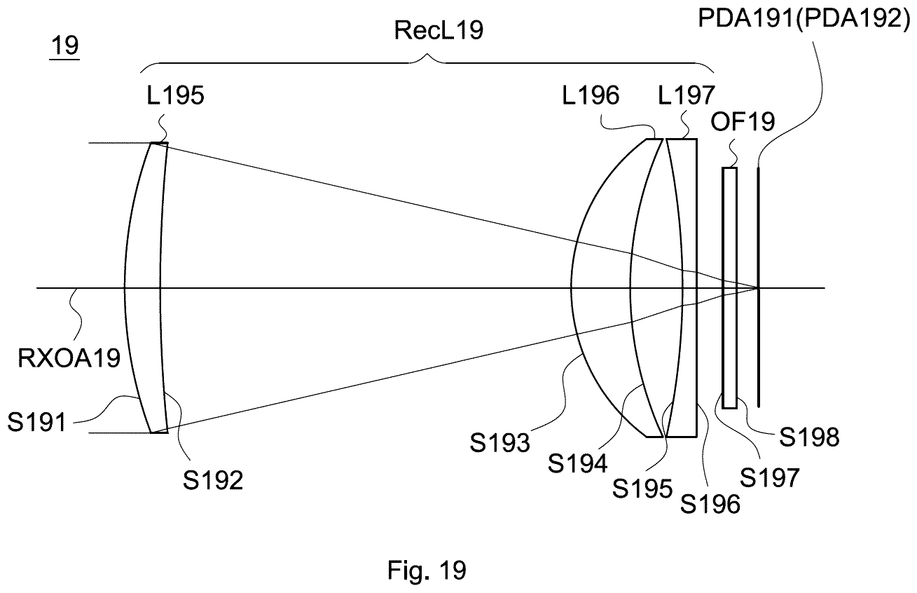

Referring to FIG. 17, FIG. 18, and FIG. 19, wherein FIG. 17 is a schematic diagram of the optical structure in the fast-axis direction of a transmitting module of a sixth embodiment of an optical apparatus in accordance with the invention, FIG. 18 is a schematic diagram of the optical structure in the slow-axis direction of the transmitting module of the sixth embodiment of the optical apparatus in accordance with the invention, and FIG. 19 is a schematic diagram of the optical structure of a receiving module of the sixth embodiment of the optical apparatus in accordance with the invention. The sixth embodiment and the fifth embodiment of the optical apparatus have the same system structure. The sixth embodiment of the optical apparatus includes a transmitting module 17 and a receiving module 19. The transmitting module 17 emits a light beam toward an object (not shown) and the object (not shown) reflects the light beam toward the receiving module 19. The transmitting module 17 includes a first lighting module array LDA171, a second lighting module array LDA172, and a collimator CL17. The first lighting module array LDA171 and the second lighting module array LDA172 are arranged on both sides of an optical axis TXOA17, wherein the optical axis TXOA17 is the symmetrical center. The first lighting module array LDA171 includes 16 pieces of lighting module 8. The 16 pieces of lighting module 8 are arranged in a straight line, so that the straight line direction is the connection direction of the slow axis-direction of each lighting module 8 (normal incident direction in FIG. 17). The second lighting module array LDA172 and the first lighting module array LDA171 have the same structure. The fast-axis direction of the lighting module 8 is the vertical direction in FIG. 17. The collimator CL17 includes a first lens L171, a second lens L172, a third lens L173, and a fourth lens L174. The first lens L171 is a meniscus lens with positive refractive power and includes a convex surface S174 facing the first lighting module array LDA171 and the second lighting module array LDA172 and a concave surface S175 facing away from the first lighting module array LDA171 and the second lighting module array LDA172, wherein the convex surface S174 is a spherical surface and the concave surface S175 is a spherical surface. The second lens L172 is a meniscus lens with negative refractive power and includes a convex surface S176 facing the first lighting module array LDA171 and the second lighting module array LDA172 and a concave surface S177 facing away from the first lighting module array LDA171 and the second lighting module array LDA172, wherein the convex surface S176 is a spherical surface and the concave surface S177 is a spherical surface. The third lens L173 is a meniscus lens with positive refractive power and includes a concave surface S178 facing the first lighting module array LDA171 and the second lighting module array LDA172 and a convex surface S179 facing away from the first lighting module array LDA171 and the second lighting module array LDA172, wherein the concave surface S178 is a spherical surface and the convex surface S179 is a spherical surface. The fourth lens L174 is a meniscus lens with positive refractive power and includes a convex surface S1710 facing the first lighting module array LDA171 and the second lighting module array LDA172 and a concave surface S1711 facing away from the first lighting module array LDA171 and the second lighting module array LDA172, wherein the convex surface S1710 is a spherical surface and the concave surface S1711 is a spherical surface. The receiving module 19 includes a first optical receiver array PDA191, a second optical receiver array PDA192, an optical filter OF19, and a receiving lens RecL19, all of which are arranged in order along an optical axis RXOA19. The first optical receiver array PDA191 includes 16 pieces of optical receiver OR11 as shown in FIG. 11. The 16 pieces of optical receiver OR11 are arranged in a straight line. The first optical receiver array PDA191 and the second optical receiver PDA192 have the same structure. The first optical receiver array PDA191 and the second optical receiver array PDA192 are arranged on both sides of the optical axis RXOA19, wherein the optical axis RXOA19 is the symmetrical center. The receiving lens RecL19 includes a fifth lens L195, a sixth lens L196, and a seventh lens L197. The fifth lens L195 is a meniscus lens with positive refractive power and includes a convex surface S191 facing away from the first optical receiver array PDA191 and the second optical receiver array PDA192 and a concave surface S192 facing the first optical receiver array PDA191 and the second optical receiver array PDA192, wherein the convex surface S191 is a spherical surface and the concave surface S192 is a spherical surface. The sixth lens L196 is a meniscus lens with positive refractive power and includes a convex surface S193 facing away from the first optical receiver array PDA191 and the second optical receiver array PDA192 and a concave surface S194 facing the first optical receiver array PDA191 and the second optical receiver array PDA192, wherein the convex surface S193 is a spherical surface and the concave surface S194 is a spherical surface. The seventh lens L197 is a plano-concave lens with negative refractive power and includes a concave surface S195 facing away from the first optical receiver array PDA191 and the second optical receiver array PDA192 and a plane surface S196 facing the first optical receiver array PDA191 and the second optical receiver array PDA192, wherein the concave surface S195 is a spherical surface. Both surfaces S197 and S198 of the optical filter OF19 are plane surfaces. The light beams are emitted by the first lighting module array LDA171. The divergence angles of the fast-axis direction light beams are compressed, so that the fast-axis direction light beams are concentrated and the collimation of the fast-axis direction light beams are improved. As for the divergence angles of the light beams in the slow-axis direction remain unchanged. Then, the light beams enter and penetrate the collimator CL17 further compressing the divergence angles of the light beams. The light beams reflected by the object enters the receiving module 19 through the fifth lens L195 and is finally received by the first optical receiver array PDA191 and the second optical receiver array PDA192. Table 8 shows the optical simulation data for the above-mentioned first lighting module array LDA171 of the transmitting module 17 in the fast-axis direction. As for the optical simulation data of the second lighting module array LDA172 in the fast-axis direction is the same as Table 8. Table 9 shows the optical simulation data for the above-mentioned first lighting module array LDA171 of the transmitting module 17 in the slow-axis direction. As for the optical simulation data of the second lighting module array LDA172 in the slow-axis direction is the same as Table 9. Table 10 shows the optical simulation data for the above-mentioned first optical receiver array PDA191 of the receiving module 19. As for the optical simulation data of the second optical receiver array PDA92 of the receiving module 19 is the same as Table 10.

TABLE 8
Fast-axis Direction Effective Focal Length: 7.22 mm

| R1C1 | R1C2 | R1C3 | R1C41 | R1C5 | R1C6 | R1C7 | R1C8 | R1C9 |
|---|---|---|---|---|---|---|---|---|
| S171 | ∞ | 0.076 | 0.01 | | | | | LS8 |
| S172 | 0.2 | 0.4 | 0.07 | 0.4 | 1.5168 | 64.1987 | 0.293 | RL8 |
| S173 | −0.2 | 3 | 0.2 | 0.4 | | | | |
| S174 | 28 | 5.5 | 4.16 | 10 | 1.9037 | 31.3150 | 59.539 | L171 |
| S175 | 52.94 | 6.011 | 4.01 | 10 | | | | |
| S176 | 64.95 | 4.6 | 3.84 | 10 | 1.9037 | 31.3150 | −49.409 | L172 |
| S177 | 25.57 | 38.855 | 3.55 | 10 | | | | |
| S178 | −168.3 | 4.7 | 5.52 | 8 | 1.4875 | 70.4405 | 108.103 | L173 |
| S179 | −40.5 | 1 | 5.74 | 8 | | | | |
| S1710 | 40.5 | 4.7 | 5.74 | 7 | 1.4875 | 70.4405 | 108.103 | L174 |
| S1711 | 168.3 | 43 | 5.54 | 7 | | | | |

R1C1: Surface Number
R1C2: Radius of Curvature (mm)
R1C3: Interval (mm)
R1C41: Fast-axis Light Beam Effective Diameter (mm)
R1C5: Lens Slow-axis Outer Diameter
R1C6: Nd
R1C7: Vd
R1C8: Effective Focal Length (mm)
R1C9: Remark

TABLE 9
Slow-axis Direction Effective Focal Length: 71.44 mm

| R1C1 | R1C2 | R1C3 | R1C42 | R1C5 | R1C6 | R1C7 | R1C8 | R1C9 |
|---|---|---|---|---|---|---|---|---|
| S171 | ∞ | 0.076 | 0.01 | | | | | LS8 |
| S172 | ∞ | 0.4 | 0.13 | 0.4 | 1.5168 | 64.1987 | | RL8 |
| S173 | ∞ | 3 | 0.18 | 0.4 | | | | |
| S174 | 28 | 5.5 | 33.15 | 34 | 1.9037 | 31.3150 | 59.539 | L171 |
| S175 | 52.94 | 6.011 | 31.78 | 34 | | | | |
| S176 | 64.95 | 4.6 | 29.27 | 34 | 1.9037 | 31.3150 | −49.409 | L172 |
| S177 | 25.57 | 38.855 | 26.20 | 34 | | | | |
| S178 | −168.3 | 4.7 | 30.73 | 34 | 1.4875 | 70.4405 | 108.103 | L173 |
| S179 | −40.5 | 1 | 31.08 | 34 | | | | |
| S1710 | 40.5 | 4.7 | 29.82 | 31 | 1.4875 | 70.4405 | 108.103 | L174 |
| S1711 | 168.3 | 43 | 28.90 | 31 | | | | |

R1C1: Surface Number
R1C2: Radius of Curvature (mm)
R1C3: Interval (mm)
R1C42: Slow-axis Light Beam Effective Diameter (mm)
R1C5: Lens Slow-axis Outer Diameter
R1C6: Nd
R1C7: Vd
R1C8: Effective Focal Length (mm)
R1C9: Remark

TABLE 10
Effective focal Length: 57.51 mm

| R1C1 | R1C2 | R1C3 | R1C41 | R1C5 | R1C6 | R1C7 | R1C8 | R1C9 |
|---|---|---|---|---|---|---|---|---|
| S191 | 44.75 | 3.8 | 19 | 32 × 19 | 1.9037 | 31.3150 | 69.989 | L195 |
| S192 | 146.85 | 44.135 | 18.5 | 32 × 19 | | | | |
| S193 | 19.85 | 6.5 | 9.19 | 32 × 13 | 1.4875 | 70.4405 | 73.103 | L196 |
| S194 | 40 | 5.619 | 7.38 | 32 × 13 | | | | |
| S195 | −71.51 | 1.4 | 5.5 | 32 × 13 | 2.0033 | 28.3163 | −71.275 | L197 |
| S196 | ∞ | 2.966 | 5.3 | 32 × 13 | | | | |
| S197 | ∞ | 1.2 | 4.5 | 30 × 5 | 1.5231 | 58.5714 | | OF19 |
| S198 | ∞ | 2.55 | 4.28 | 30 × 5 | | | | |
| S191 | 44.75 | 3.8 | 31 | 32 × 19 | 1.9037 | 31.3150 | 69.989 | L195 |
| S192 | 146.85 | 44.135 | 30.86 | 32 × 19 | | | | |
| S193 | 19.85 | 6.5 | 29.67 | 32 × 13 | 1.4875 | 70.4405 | 73.103 | L196 |
| S194 | 40 | 5.619 | 28.08 | 32 × 13 | | | | |
| S195 | −71.51 | 1.4 | 26.97 | 32 × 13 | 2.0033 | 28.3163 | −71.275 | L197 |
| S196 | ∞ | 2.966 | 26.53 | 32 × 13 | | | | |
| S197 | ∞ | 1.2 | 25.91 | 30 × 5 | 1.5231 | 58.5714 | | OF19 |
| S198 | ∞ | 2.55 | 25.75 | 30 × 5 | | | | |

R1C1: Surface Number
R1C2: Radius of Curvature (mm)
R1C3: Interval (mm)
R1C41: Fast-axis Light Beam Effective Diameter (mm)
R1C42: Slow-axis Light Beam Effective Diameter (mm)
R1C5: Lens Slow-axis Outer Diameter
R1C6: Nd
R1C7: Vd
R1C8: Effective Focal Length (mm)
R1C9: Remark

Table 11 shows the parameters and condition values for conditions (3)-(13) in accordance with the sixth embodiment of the optical apparatus of the invention. It can be seen from Table 11 that the sixth embodiment of the optical apparatus of the invention satisfies the conditions (3)-(13).

TABLE 11

| | | | | | |
|---|---|---|---|---|---|
| Y | 31 mm | fts | 71.4 mm | ω | 13.2 degrees |
| L | 2 mm | d | 110 mm | H | 24.8 mm |
| fr | 57.51 mm | β | 0.8 degrees | I | 1.6 mm |
| Ang | 88 degrees | y | 3.6 mm | ftf | 7.22 mm |
| α | 1.445 degrees | h | 2.9 mm | n | 16 |
| Y/(2 × | 0.93 | Y/ | 1.00 | H/(2 × | 0.92 |
| fts × | | ((n − 1) × | | fr × | |
| tan(ω)) | | L + d) | | tan(ω)) | |
| L/(2 × | 1.00 | ω/(n × β) | 1.03 | I/(2 × | 1.00 |
| fts × | | | | fr × | |
| tan(β)) | | | | tan(β)) | |
| y/(2 × | 1.00 | h/(2 × | 1.00 | α/β | 1.81 |
| fts × | | fr × | | | |
| tan(α)) | | tan(α)) | | | |

The seventh embodiment of the optical apparatus of the invention is described below. The seventh embodiment of the optical apparatus (not shown) includes a transmitting module, a receiving module, and an optical path turning element. The transmitting module includes a first lighting module array, a collimator, and a reflective element at transmitting end. The first lighting module array includes 16 pieces of lighting module 8 as shown in FIG. 8. The 16 pieces of lighting module 8 are arranged along the slow-axis direction of the lighting module 8 at equal interval. The first optical receiver array includes 16 pieces of optical receiver OR11 as shown in FIG. 11. The light beams emitted by the first lighting module array first enters and penetrates the collimator, and then is reflected by the reflective element at transmitting end toward the optical path turning element, then, the optical path is changed by the optical path turning element toward an object. The object reflects the light beams toward the optical path turning element and the optical path turning element changes the optical path of the light beams toward the reflective element at receiving end, the reflective element at receiving end reflects the light beams, so that the light beams enters and penetrates the receiving lens, and finally enters the first optical receiver array and received by the optical receivers. The above-mentioned optical path turning element is a rotatable polygon mirror or a rotatable reflective mirror. During operation, the rotatable polygon mirror or the rotatable reflective mirror can rotate to increase the scanning range of the light beams.

The collimator of the above-mentioned seventh embodiment (not shown) of the optical apparatus includes a first lens, wherein the first lens is a biconvex lens with positive refractive power and includes a convex surface facing the first lighting module array and another convex surface facing away from the first lighting module array. The first lens is an aspheric lens and the optical simulation data of the first lens can be as the first lens L61 shown in Table 4.

The collimator of the above-mentioned seventh embodiment (not shown) of the optical apparatus further includes a second lens disposed between the first lighting module array and the first lens, wherein the second lens is a plano-concave lens with negative refractive power and includes a concave surface facing the first lighting module array and a plane surface facing away from the first lighting module array. The second lens is a spherical lens and the optical simulation data of the second lens can be as the second lens L52 shown in Table 3.

The transmitting module of the above-mentioned seventh embodiment (not shown) of the optical apparatus further includes a first prism and a second prism, wherein the first prism is disposed between the first lighting module array and the second prism and the second prism is disposed between the first prism and the collimator. The collimator includes a first lens, a second lens, a third lens, and a fourth lens, all of which are arranged in order along an optical axis. The first lens is a meniscus lens with negative refractive power and includes a concave surface facing the first lighting module array and a convex surface facing away from the first lighting module array. The first lens is a spherical lens. The second lens is a meniscus lens with positive refractive power and includes a concave surface facing the first lighting module array and a convex surface facing away from the first lighting module array. The second lens is a spherical lens. The third lens is a meniscus lens with negative refractive power and includes a convex surface facing the first lighting module array and a concave surface facing away from the first lighting module array. The third lens is a spherical lens. The fourth lens is a biconvex lens with positive refractive power and includes a convex surface facing the first lighting module array and another convex surface facing away from the first lighting module array. The fourth lens is a spherical lens. The third lens and the fourth lens are cemented. The optical simulation data of the first prism, the second prism, the first lens, the second lens, the third lens, and the fourth lens can be as the first prism P71, the second prism P72, the first lens L71, the second lens L72, the third lens L73, and the fourth lens L74 shown in Table 5.

The collimator of the above-mentioned seventh embodiment (not shown) of the optical apparatus includes a first lens, a second lens, a third lens, and a fourth lens, all of which are arranged in order along an optical axis. The first lens is a meniscus lens with positive refractive power and includes a convex surface facing the first lighting module array and a concave surface facing away from the first lighting module array. The first lens is a spherical lens. The second lens is a meniscus lens with negative refractive power and includes a convex surface facing the first lighting module array and a concave surface facing away from the first lighting module array. The second lens is a spherical lens. The third lens is a meniscus lens with positive refractive power and includes a concave surface facing the first lighting module array and a convex surface facing away from the first lighting module array. The third lens is a spherical lens. The fourth lens is a meniscus lens with positive refractive power and includes a convex surface facing the first lighting module array and a concave surface facing away from the first lighting module array. The fourth lens is a spherical lens. The optical simulation data of the first lens, the second lens, the third lens, and the fourth lens can be as the first lens L71, the second lens L72, the third lens L73, and the fourth lens L74 shown in Table 8.

The receiving lens of the above-mentioned seventh embodiment (not shown) of the optical apparatus includes a fifth lens, a sixth lens, and a seventh lens, all of which are arranged in order along an optical axis. The fifth lens is a meniscus lens with positive refractive power and includes a convex surface facing away from the first optical receiver array and a concave surface facing the first optical receiver array. The fifth lens is a spherical lens. The sixth lens is a meniscus lens with positive refractive power and includes a convex surface facing away from the first optical receiver array and a concave surface facing the first optical receiver array. The sixth lens is a spherical lens. The seventh lens is a plano-concave lens with negative refractive power and includes a concave surface facing away from the first optical receiver array and a plane surface facing the first optical receiver array. The seventh lens is a spherical lens. The optical simulation data of the fifth lens, the sixth lens, and the seventh lens can be as the fifth lens L195, the sixth lens L196, and the seventh lens L197 shown in Table 10.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A lighting module comprising:
a lighting unit;
a cylindrical optical element;
a supporting unit; and
a base;
wherein the supporting unit connects the base and a part of the supporting unit is higher than a junction of the base and the supporting unit;
wherein the lighting unit is disposed on the base and comprises a lighting surface which emits a light beam;
wherein the cylindrical optical element comprises an incident surface and both ends of the cylindrical optical element are respectively connected to the supporting unit making the incident surface facing the lighting surface and having an interval from the lighting unit to the incident surface, and the light beam emitted by the lighting surface enters the cylindrical optical element from the incident surface;
wherein the lighting module satisfies following condition:
$$2 \leq D / E \leq 6 ;$$
wherein D is a diameter of the cylindrical optical element and E is the interval from the lighting unit to the incident surface.

2. The lighting module as claimed in claim 1, wherein the lighting unit is a laser diode; the cylindrical optical element is a rod lens, a cylindrical lens, an optical fiber, or a fast-axis collimating lens; and one of the cylindrical optical elements can correspond to one or more of the lighting units.

3. An optical apparatus comprising:
a transmitting module; and
a receiving module;
wherein the transmitting module comprises a lighting module as claimed in claim 1 and a collimator;
wherein the receiving module comprises a receiving lens and an optical receiver;
wherein the light beam emitted by the lighting module first enters and penetrates the collimator, then enters an object and is reflected by the object, then enters and penetrates the receiving lens, and finally enters the optical receiver.

4. An optical apparatus comprising:
a transmitting module; and
a receiving module;
wherein the transmitting module comprises a lighting module as claimed in claim 2 and a collimator;
wherein the receiving module comprises a receiving lens and an optical receiver;
wherein the light beam emitted by the lighting module first enters and penetrates the collimator, then enters an object and is reflected by the object, then enters and penetrates the receiving lens, and finally enters the optical receiver.

5. An optical apparatus comprising:
a transmitting module; and
a receiving module;
wherein the transmitting module comprises a first lighting module array and a collimator, the first lighting module array comprises a plurality of lighting modules as claimed in claim 1 and the lighting modules are arranged along a slow-axis direction of the lighting module;
wherein the lighting surfaces comprise respectively a center point;
wherein the receiving module comprises a receiving lens and a first optical receiver array and the first optical receiver array comprises a plurality of optical receivers;
wherein the light beams emitted by the first lighting module array first enters and penetrates the collimator respectively, then enters an object and is reflected by the object, then enters and penetrates the receiving lens, and finally enters the optical receivers of the first optical receiver array, respectively;
wherein the optical apparatus satisfies at least one of following conditions:
$$Y \leq 31 mm ;$$
$$0.9 \leq Y / ( 2 \times fts \times tan ( ω ) ) \leq 1.1 ;$$
$$0.9 \leq Y / ( ( n - 1 ) \times L + d ) \leq 1.1 ;$$
$$0.9 \leq H / ( 2 \times fr \times tan ( ω ) ) \leq 1.1 ;$$
wherein Y is an interval from the first lighting surface to the last lighting surface along the slow-axis direction for the first lighting module array; n is a total number of the lighting modules; L is an interval between two center points of the two lighting surfaces of the two adjacent lighting modules for the first lighting module array; d is a slow-axis length of the lighting surface; fts is an effective focal length of the lighting module in the slow-axis direction for the transmitting module; ω is a half field of view angle of the transmitting module; H is an interval from a center point of the first optical receiver to a center point of the last optical receiver for the first optical receiver array; and fr is an effective focal length of the receiving module.

6. The optical apparatus as claimed in claim 5, wherein the optical apparatus satisfies at least one of following conditions:
$$0.90 \leq L / ( 2 \times fts \times tan ( β ) ) \leq 1.1 ;$$
$$0.9 \leq ω / ( n \times β ) \leq 1.1 ;$$
$$0.9 \leq I / ( 2 \times fr \times tan ( β ) ) \leq 1.1 ;$$
wherein L is the interval between the two center points of the two lighting surfaces of the two adjacent lighting modules for the first lighting module array; fts is the effective focal length of the lighting module in the slow-axis direction for the transmitting module; β is a half of an angle between the two slow-axis direction beams of the two adjacent lighting modules after passing through the collimator for the first lighting module array; ω is the half field of view angle of the transmitting module; n is the total number of the lighting modules; I is an interval between two center points of the two adjacent optical receivers for the first optical receiver array; and fr is the effective focal length of the receiving module.

7. The optical apparatus as claimed in claim 5, wherein a first virtual line is perpendicular to the lighting surface, passes through its center point, and connects the incident surface to a virtual point; a second virtual line connects the center point of any adjacent lighting surfaces and the virtual point; Ang is an angle between the first virtual line and the second virtual line; and the optical apparatus satisfies following condition:
45 degrees≤Ang≤89 degrees.

8. The optical apparatus as claimed in claim 5, further comprising a second lighting module array and a second optical receiver array, wherein:
the second lighting module array comprises another plurality of lighting modules as claimed in claim 1 and the another plurality of lighting modules are arranged along another slow-axis direction of the another lighting module;
the first lighting module array and the second lighting module array are respectively disposed on both sides of an optical axis of the collimator;
the second optical receiver array comprises another plurality of optical receivers;
the first optical receiver array and the second optical receiver array are respectively disposed on both sides of an optical axis of the receiving lens; and
the light beams emitted by the second lighting module array first enters and penetrates the collimator respectively, then enters the object and is reflected by the object, then enters and penetrates the receiving lens, and finally enters the another plurality of optical receivers of the second optical receiver array respectively.

9. The optical apparatus as claimed in claim 6, further comprising a second lighting module array and a second optical receiver array, wherein:
the second lighting module array comprises another plurality of lighting modules as claimed in claim 1 and the another plurality of lighting modules are arranged along another slow-axis direction of the another lighting module;
the first lighting module array and the second lighting module array are respectively disposed on both sides of an optical axis of the collimator;
the second optical receiver array comprises another plurality of optical receivers;
the first optical receiver array and the second optical receiver array are respectively disposed on both sides of an optical axis of the receiving lens; and
the light beams emitted by the second lighting module array first enters and penetrates the collimator respectively, then enters the object and is reflected by the object, then enters and penetrates the receiving lens, and finally enters the another plurality of optical receivers of the second optical receiver array respectively.

10. The optical apparatus as claimed in claim 7, further comprising a second lighting module array and a second optical receiver array, wherein:
the second lighting module array comprises another plurality of lighting modules as claimed in claim 1 and the another plurality of lighting modules are arranged along another slow-axis direction of the another lighting module;
the first lighting module array and the second lighting module array are respectively disposed on both sides of an optical axis of the collimator;
the second optical receiver array comprises another plurality of optical receivers;
the first optical receiver array and the second optical receiver array are respectively disposed on both sides of an optical axis of the receiving lens; and
the light beams emitted by the second lighting module array first enters and penetrates the collimator respectively, then enters the object and is reflected by the object, then enters and penetrates the receiving lens, and finally enters the another plurality of optical receivers of the second optical receiver array respectively.

11. The optical apparatus as claimed in claim 8, wherein the optical apparatus satisfies at least one of following conditions:
$$0.90 \leq y / ( 2 \times fts \times tan ( α ) ) \leq 1.1 ;$$
$$0.9 \leq h / ( 2 \times fr \times tan ( α ) ) \leq 1 \text{.10} ;$$
$$1.71 \leq α / β \leq 1 \text{.89} ;$$
wherein y is a center interval from the first lighting module array to the second lighting module array; fts is the effective focal length of the lighting module in the slow-axis direction for the transmitting module; α is a half of an angle between the two fast-axis direction beams of the two closest lighting modules respectively in the first lighting module array and the second lighting module array after passing through the collimator; h is a center interval from the first optical receiver array to the second optical receiver array; fr is the effective focal length of the receiving module; and β is the half of the angle between the two slow-axis direction beams of the two adjacent lighting modules after passing through the collimator for the first lighting module array.

12. The optical apparatus as claimed in claim 9, wherein the optical apparatus satisfies at least one of following conditions:
$$0.90 \leq y / ( 2 \times fts \times tan ( α ) ) \leq 1.1 ;$$
$$0.9 \leq h / ( 2 \times fr \times tan ( α ) ) \leq 1 \text{.10} ;$$
$$1.71 \leq α / β \leq 1 \text{.89} ;$$
wherein y is a center interval from the first lighting module array to the second lighting module array; fts is the effective focal length of the lighting module in the slow-axis direction for the transmitting module; α is a half of an angle between the two fast-axis direction beams of the two closest lighting modules respectively in the first lighting module array and the second lighting module array after passing through the collimator; h is a center interval from the first optical receiver array to the second optical receiver array; fr is the effective focal length of the receiving module; and β is the half of the angle between the two slow-axis direction beams of the two adjacent lighting modules after passing through the collimator for the first lighting module array.

13. The optical apparatus as claimed in claim 10, wherein the optical apparatus satisfies at least one of following conditions:
$$0.90 \leq y / ( 2 \times fts \times tan ( α ) ) \leq 1.1 ;$$
$$0.9 \leq h / ( 2 \times fr \times tan ( α ) ) \leq 1 \text{.10} ;$$
$$1.71 \leq α / β \leq 1 \text{.89} ;$$
wherein y is a center interval from the first lighting module array to the second lighting module array; fts is the effective focal length of the lighting module in the slow-axis direction for the transmitting module; α is a half of an angle between the two fast-axis direction beams of the two closest lighting modules respectively in the first lighting module array and the second lighting module array after passing through the collimator; h is a center interval from the first optical receiver array to the second optical receiver array; fr is the effective focal length of the receiving module; and β is the half of the angle between the two slow-axis direction beams of the two adjacent lighting modules after passing through the collimator for the first lighting module array.

14. An optical apparatus comprising:
a transmitting module; and
a receiving module;
wherein the transmitting module comprises a first lighting module array, a collimator, and a reflective element at transmitting end;
wherein the first lighting module array comprises a plurality of lighting modules as claimed in claim 1 and the lighting modules are arranged along a slow-axis direction of the lighting module;
wherein the receiving module comprises a receiving lens, a first optical receiver array, and a reflective element at receiving end, and the first optical receiver array comprises a plurality of optical receivers;
wherein the light beams emitted by the first lighting module array first enters and penetrates the collimator, respectively, then reflected by the reflective element at transmitting end toward an object, the object reflects the light beams toward the reflective element at receiving end, the reflective element at receiving end reflects the light beams causing the light beams entering and penetrating the receiving lens, and finally enters the first optical receiver array and received by the optical receivers.

15. The optical apparatus as claimed in claim 14, wherein the collimator comprises a first lens, the first lens is a biconvex lens with positive refractive and comprises a convex surface facing the first lighting module array and another convex surface facing away from the first lighting module array, and the first lens is an aspheric lens.

16. The optical apparatus as claimed in claim 15, wherein the collimator further comprises a second lens disposed between the first lighting module array and the first lens, the second lens is a plano-concave lens with negative refractive power and comprises a concave surface facing the first lighting module array and a plane surface facing away from the first lighting module array, and the second lens is a spherical lens.

17. The optical apparatus as claimed in claim 14, wherein the transmitting module further comprises a first prism and a second prism, the first prism is disposed between the first lighting module array and the second prism, the second prism is disposed between the first prism and the collimator, and the collimator comprises a first lens, a second lens, a third lens, and a fourth lens;
wherein the first lens, the second lens, the third lens, and the fourth lens are arranged in order from an optical axis;
wherein the first lens is a meniscus lens with negative refractive power and comprises a concave surface facing the first lighting module array and a convex surface facing away from the first lighting module array, and the first lens is a spherical lens;
wherein the second lens is a meniscus lens with positive refractive power and comprises a concave surface facing the first lighting module array and a convex surface facing away from the first lighting module array, and the second lens is a spherical lens;
wherein the third lens is a meniscus lens with negative refractive power and comprises a convex surface facing the first lighting module array and a concave surface facing away from the first lighting module array, and the third lens is a spherical lens;
wherein the fourth lens is a biconvex lens with positive refractive power and comprises a convex surface facing the first lighting module array and another convex surface facing away from the first lighting module array, and the fourth lens is a spherical lens;
wherein the third lens and the fourth lens are cemented.

18. The optical apparatus as claimed in claim 14, wherein the collimator comprises a first lens, a second lens, a third lens, and a fourth lens;
wherein the first lens, the second lens, the third lens, and the fourth lens are arranged in order from an optical axis;
wherein the first lens is a meniscus lens with positive refractive power and comprises a convex surface facing the first lighting module array and a concave surface facing away from the first lighting module array, and the first lens is a spherical lens;
wherein the second lens is a meniscus lens with negative refractive power and comprises a convex surface facing the first lighting module array and a concave surface facing away from the first lighting module array, and the second lens is a spherical lens;
wherein the third lens is a meniscus lens with positive refractive power and comprises a concave surface facing the first lighting module array and a convex surface facing away from the first lighting module array, and the third lens is a spherical lens;
wherein the fourth lens is a meniscus lens with positive refractive power and comprises a convex surface facing the first lighting module array and a concave surface facing away from the first lighting module array, and the fourth lens is a spherical lens.

19. The optical apparatus as claimed in claim 14, wherein the receiving lens comprises a fifth lens, a sixth lens, and a seventh lens;
wherein the fifth lens, the sixth lens, and the seventh lens are arranged in order from an optical axis;
wherein the fifth lens is a meniscus lens with positive refractive power and comprises a convex surface facing away from the first optical receiver array and a concave surface facing the first optical receiver array, and the fifth lens is a spherical lens;
wherein the sixth lens is a meniscus lens with positive refractive power and comprises a convex surface facing away from the first optical receiver array and a concave surface facing the first optical receiver array, and the sixth lens is a spherical lens;
wherein the seventh lens is a plano-concave lens with negative refractive power and comprises a concave surface facing away from the first optical receiver array and a plane surface facing the first optical receiver array, and the seventh lens is a spherical lens.

20. The optical apparatus as claimed in claim 14, further comprising an optical path turning element disposed between the reflective element at transmitting end and the object, so that the light beams first reflected by the reflective element at transmitting end toward the optical path turning element, then changes the optical path through the optical path turning element toward the object, the object reflects the light beams toward the optical path turning element, then the optical path turning element changes the optical path of the light beams toward the reflective element at receiving end, and the optical path turning element is a rotatable polygon mirror or a rotatable reflective mirror.
